(19) United States
(12) Patent Application Publication
(10) Pub. No.: US 2025/0262877 A1
(43) Pub. Date: Aug. 21, 2025

(54) Liquid Ejecting Head And Liquid Ejecting Apparatus

(71) Applicant: SEIKO EPSON CORPORATION, Tokyo (JP)

(72) Inventors: Hiroaki OKUI, Azumino (JP); Shun KATSUIE, Matsumoto (JP); Hirokazu YANAGIHARA, Chino (JP); Ayumi YOKOO, Matsumoto (JP); Yu HASEGAWA, Shiojiri (JP)

(21) Appl. No.: 19/053,520

(22) Filed: Feb. 14, 2025

(30) Foreign Application Priority Data
Feb. 16, 2024 (JP) 2024-022228

(51) Int. Cl. B41J 25/34; B41J 29/02; B41J 29/13

(52) U.S. Cl. CPC B41J 25/34; B41J 29/02; B41J 29/13; B41J 2202/19; B41J 2202/20

(57) ABSTRACT

A liquid ejecting head includes multiple head modules to eject a liquid in a first direction, multiple metallic sub-holders each holding at least one of the head modules, and a metallic holder to which the multiple sub-holders are fixed in a detachably-attached manner. Each sub-holder includes a first alignment portion. The holder includes multiple second alignment portions each of which is inserted into or receives one of the first alignment portions, thereby positioning the multiple sub-holders with respect to the holder.

The present application is based on, and claims priority from JP Application Serial Number 2024-022228, filed Feb. 16, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

Heretofore, there have been proposed liquid ejecting apparatuses each including a liquid ejecting head to eject liquids such as inks to media such as print sheets.

A liquid ejecting head described in JP-A-2022-42753 includes multiple head chips (head modules), a fixing plate, and a holder. The multiple head chips are stored in a space surrounded by the fixing plate and the holder. The multiple head chips are aligned with the fixing plate and fixed to the fixating plate with an adhesive. The fixing plate is fixed to the holder with an adhesive.

For a case where one or some of the multiple head modules are broken, there is a demand to repair the liquid ejecting head by removing and replacing only the broken head modules with new head modules.

However, in the related art, it is necessary to detach the fixing plate from the holder in order to remove one or some of the head modules from the holder. For this reason, there is a risk of a disorder occurring in the alignment of the multiple head modules with the fixing plate. Therefore, in work of repairing a liquid ejecting head by replacing one or some of multiple modules included in the liquid ejecting head, there is a demand for a mechanism enabling the multiple head modules to be aligned with each other.

### SUMMARY

A liquid ejecting head according to an aspect of the present disclosure includes: a plurality of head modules each of which ejects a liquid in a first direction; a plurality of metallic sub-holders each of which holds at least one head module among the plurality of head modules; and a metallic holder to which the plurality of sub-holders are fixed in a detachably-attached manner. Each of the plurality of sub-holders includes a first alignment portion. The holder includes a plurality of second alignment portions which are inserted into or receive a plurality of the first alignment portions in a press-fit manner, thereby positioning the plurality of sub-holders with respect to the holder.

A liquid ejecting apparatus according to an aspect of the present disclosure includes a plurality of the liquid ejecting heads and a unit base which holds the plurality of liquid ejecting heads.

In the liquid ejecting head according to the aspect of the present disclosure, the holder includes a fourth alignment portion which is inserted into or receives one of a plurality of third alignment portions provided to a unit base which holds a plurality of the liquid ejecting heads, thereby positioning the liquid ejecting head with respect to the unit base.

A liquid ejecting apparatus according to an aspect of the present disclosure includes a plurality of the liquid ejecting heads and a unit base which includes the plurality of third alignment portions and holds the plurality of liquid ejecting heads.

### BRIEF DESCRIPTION OF THE DRAWINGS

FIG. 1 is a schematic diagram illustrating a structural example of a liquid ejecting apparatus according to a first embodiment.

FIG. 2 is a plan view illustrating a liquid ejecting head illustrated in FIG. 1.

FIG. 3 is a perspective cross-sectional view of the liquid ejecting head illustrated in FIG. 2.

FIG. 4 is a cross-sectional view of the liquid ejecting head illustrated in FIG. 3 viewed in a direction along an X axis.

FIG. 5 is a cross-sectional view of the liquid ejecting head illustrated in FIG. 3 viewed in a direction along a Y axis.

FIG. 6 is an underside view of the liquid ejecting head illustrated in FIG. 3.

FIG. 7 is a cross-sectional view of a chip included in a head module illustrated in FIG. 4.

FIG. 8 is a topside view of channel orifice forming members included in the head modules illustrated in FIG. 5.

FIG. 9 is an underside view of common channel members illustrated in FIG. 5.

FIG. 10 is a topside view of the common channel members illustrated in FIG. 5.

FIG. 11 is a topside view of seal members illustrated in FIG. 5.

FIG. 12 is a topside view of sub-holders illustrated in FIG. 5.

FIG. 13 is a topside view of an upper portion of a holder illustrated in FIG. 5.

FIG. 14 is a view illustrating a lower portion of the holder illustrated in FIG. 5.

FIG. 15 is a cross-sectional view of a part of a liquid ejecting head in a first modification.

FIG. 16 is a cross-sectional view of a part of the liquid ejecting head in the first modification.

FIG. 17 is a topside view of the liquid ejecting head in the first modification.

FIG. 18 is a cross-sectional view of a part of a liquid ejecting head in a second modification.

FIG. 19 is a cross-sectional view of a part of the liquid ejecting head in the second modification.

FIG. 20 is a cross-sectional view of a part of a liquid ejecting head in a third modification.

FIG. 21 is a cross-sectional view of a part of the liquid ejecting head in the third modification.

FIG. 22 is a view illustrating a second member included in a holder in the third modification.

FIG. 23 is a cross-sectional view of a part of a liquid ejecting head in a fifth modification.

FIG. 24 is a cross-sectional view illustrating a seal member and its surrounding area in a sixth modification.

FIG. 25 is a cross-sectional view of a part of a liquid ejecting head in the sixth modification.

FIG. 26 is a cross-sectional view illustrating a seal member and its surrounding area in a seventh modification.

FIG. 27 is a cross-sectional view illustrating a first alignment portion and a second alignment portion in an eighth modification.

### DESCRIPTION OF EMBODIMENTS

Hereinafter, preferred embodiments of the present disclosure will be described with reference to the accompanying drawings. In the drawings, the dimensions and scale of each component are illustrated differently from actual ones as appropriate, and some parts of the drawings are schematically illustrated to facilitate understanding. The scope of the present disclosure is not limited to the following embodiments unless particularly limited in the following description. A phrase “an element β on an element γ” means not only a structure in which the element γ and the element β are in direct contact with each other, but also a structure in which the element γ and the element β are out of direct contact with each other. A phrase “an element γ and an element β are equal to each other” means that the element γ and the element β are substantially equal to each other, including a measurement error, a manufacturing error, or the like. A phrase “an element γ and an element β are the same as each other” means that the element γ and the element β are substantially the same as each other, including a measurement error, a manufacturing error, or the like.

### 1. First Embodiment

### 1-1. Overall Structure of Liquid Ejecting Apparatus 100

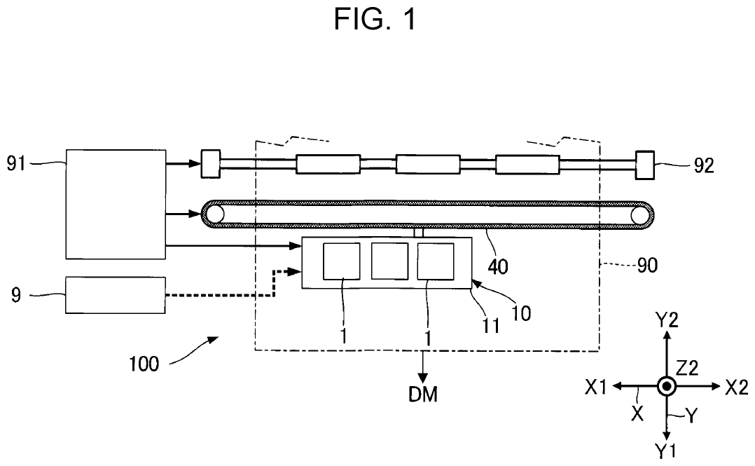

FIG. 1 is a schematic diagram illustrating a structural example of a liquid ejecting apparatus 100 according to a first embodiment. The following description will be given by using an X axis, a Y axis, and a Z axis, which are orthogonal to each other, as needed for convenience of description. Moreover, one of directions along the X axis is referred to as an X1 direction, and the direction opposite to the X1 direction is referred to as an X2 direction. Similarly, one of directions along the Y axis is referred to as a Y1 direction, and the direction opposite to the Y1 direction is referred to as a Y2 direction. One of directions along the Z axis is referred to as a Z1 direction, and the direction opposite to the Z1 direction is referred to as a Z2 direction. The Z1 direction is equivalent to a “first direction”. The Z2 direction is equivalent to “a second direction opposite to the first direction”. A side in the Z1 direction relative to a certain point in is referred to as a “lower side or underside”, whereas a side in the Z2 direction relative to the certain point is referred to as an “upper side or topside”. A view seen in the Z1 direction or the Z2 direction is referred to as a “plan view”.

As illustrated in FIG. 1, the liquid ejecting apparatus 100 includes a liquid reservoir section 9, a control unit 91, a transport section 92, a head unit 10, and a movement mechanism 40.

The liquid reservoir section 9 is a container for storing the ink. Examples of specific modes of the liquid reservoir section 9 include a cartridge removably mounted on the liquid ejecting apparatus 100, a bag-shaped ink pack formed of a flexible film, an ink tank refillable with the ink, and so on. The type of the ink stored in the liquid reservoir section 9 is not particularly limited and may be any type of ink.

The control unit 91 controls operations of elements in the liquid ejecting apparatus 100. The control unit 91 includes, for example, a processor circuit such as a central processing unit (CPU) or a field programmable gate array (FPGA) and a storage circuit such as a semiconductor memory, and controls the operations of the elements in the liquid ejecting apparatus 100.

The transport section 92 transports a medium 90 in a direction DM under the control of the control unit 91. In the present embodiment, the direction DM is the Y1 direction. In the example illustrated in FIG. 1, the transport section 92 includes a transport roller that is long along the X axis, and a motor that rotates the transport roller. The transport section 92 is not limited to a structure using the transport roller, and may have a structure using, for example, a drum or an endless belt that transports the medium 90 while adsorbing the medium 90 on its outer circumferential surface by electrostatic force or the like.

The movement mechanism 40 includes a transport belt to which a unit base 11 of the head unit 10 is fixed, and reciprocates the head unit 10 in the X1 and X2 directions under the control of the control unit 91. The head unit 10 ejects the ink supplied from the liquid reservoir section 9 to the medium 90 in the Z1 direction from each of multiple nozzles N under the control of the control unit 91. As a result of concurrent operations of the head unit 10 ejecting the ink and the movement mechanism 40 moving the head unit 10, an image is formed with the ink on a surface of the medium 90.

The number and layout of the multiple liquid ejecting heads 1 included in the head unit 10 are not limited to those in the example illustrated in FIG. 1 and may be determined as needed. In a case where the head unit 10 is configured to be able to circulate the ink, the head unit 10 may be connected to the liquid reservoir section 9 via a circulation mechanism for circulating the ink in the head unit 10.

### 1-2. Head Unit 10

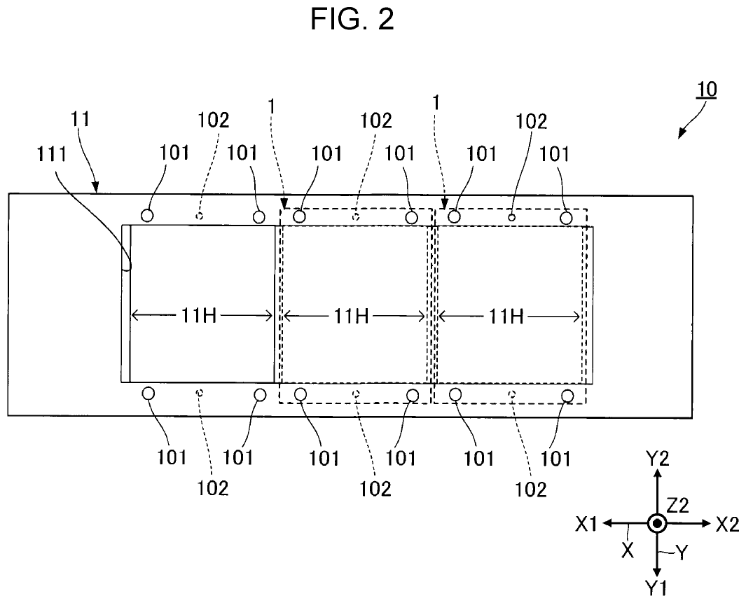

FIG. 2 is a plan view illustrating the head unit 10 illustrated in FIG. 1. As illustrated in FIG. 2, the head unit 10 includes the unit base 11 and the multiple liquid ejecting heads 1. The multiple liquid ejecting heads 1 are fixed to the unit base 11. The unit base 11 is a member that holds the multiple liquid ejecting heads 1. In the example illustrated, the number of liquid ejecting heads 1 for the unit base 11 is not particularly limited and may be any number equal to or more than 1.

The unit base 11 is, for example, a plate-shaped member whose thickness direction is a direction along the Z axis. The unit base 11 is provided with a dented portion 111. The dented portion 111 is a recess provided in the unit base 11. The bottom surface of the dented portion 111 is provided with multiple through holes 11H. The planar shape of each through hole 11H is, for example, a rectangular shape. The through hole 11H is provided for each liquid ejecting head 1. A part of the liquid ejecting head 1 is inserted into each through hole 11H. In FIG. 2, one of the liquid ejecting heads 1 arranged in the unit base 11 is omitted from the illustration for the purpose of presenting the through hole 11H.

The unit base 11 is also provided with four mounting holes 101 and two third alignment portions 102 for each through hole 11H. The four mounting holes 101 and the two third alignment portions 102 are provided outside the through hole 11H in the plan view. Here, the numbers and the layout of the mounting holes 101 and the third alignment portions 102 are not limited to those illustrated in FIG. 2, but may be determined as needed.

The mounting holes 101 are provided, for example, near four corners of the through hole 11H in the plan view. The mounting holes 101 are used to mount the liquid ejecting head 1 on the unit base 11. For example, the mounting holes 101 pass through the unit base 11 along the thickness direction.

For example, each of the third alignment portions 102 is provided between the two mounting holes 101 arranged in the direction along the X axis while being apart from these mounting holes 101. The third alignment portions 102 are used to position each liquid ejecting head 1 in mounting the liquid ejecting head 1 onto the unit base 11. Each third alignment portion 102 is, for example, a bottomed slot opened in a surface of the unit base 11 facing in the Z1 direction. Each third alignment portion 102 may be regarded as a dented portion formed in the surface of the unit base 11 facing in the Z1 direction.

Here, the mounting holes 101 do not have to pass through the unit base 11 in the thickness direction. Likewise, the third alignment portions 102 may pass through the unit base 11 in the thickness direction. The shape of the unit base 11 is not limited to the plate shape, and may be a box shape.

As described above, the liquid ejecting apparatus 100 includes the multiple liquid ejecting heads 1 and the unit base 11 to which the multiple liquid ejecting heads 1 are fixed. Such liquid ejecting apparatus 100 includes the liquid ejecting heads 1 to be described later. As will be described later, the multiple liquid ejecting heads 1 can be each detachably mounted on the unit base 11, and are configured such that alignment of the multiple liquid ejecting heads 1 with high precision can be achieved. For this reason, even if any of the multiple liquid ejecting heads 1 is replaced, the liquid ejecting apparatus 100 is capable of keeping the print quality from deteriorating.

### 1-3. Liquid Ejecting Head 1

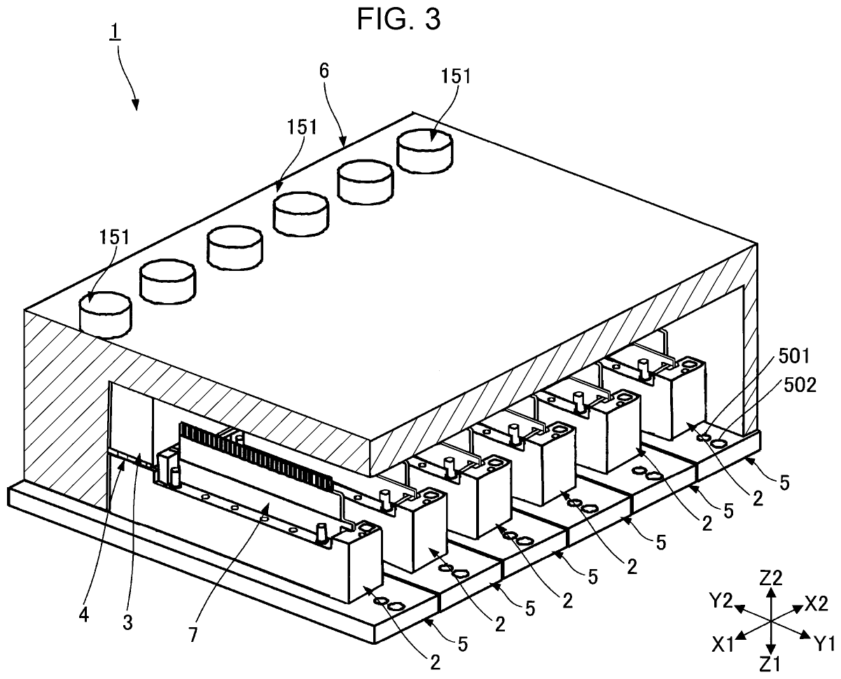

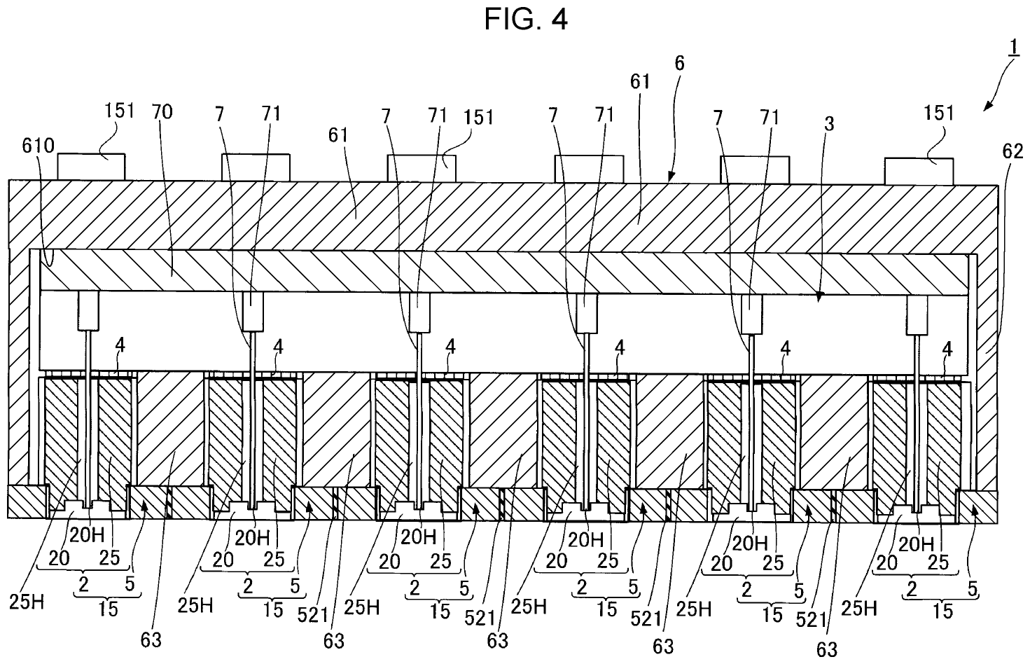

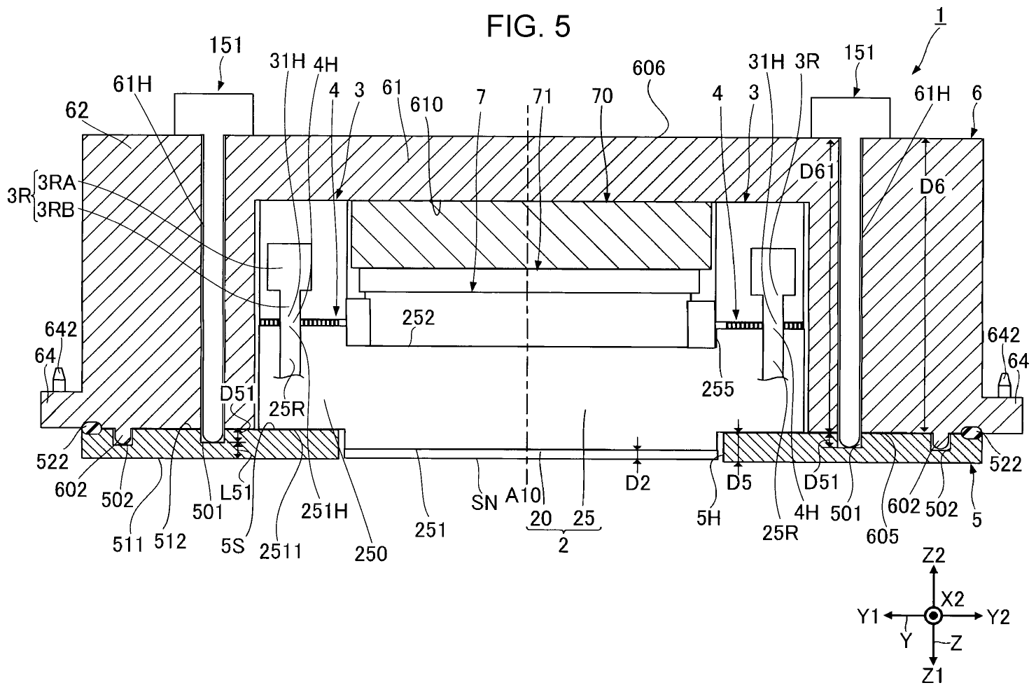

FIG. 3 is a perspective cross-sectional view of the liquid ejecting head 1 illustrated in FIG. 2. FIG. 4 is a cross-sectional view of the liquid ejecting head 1 illustrated in FIG. 3 viewed in the direction along the X axis. FIG. 5 is a cross-sectional view of the liquid ejecting head 1 illustrated in FIG. 3 viewed in the direction along the Y axis. As illustrated in FIG. 5, in the present embodiment, the liquid ejecting head 1 has a structure approximately symmetrical about a central imaginary plane A10 along an X-Z plane. However, the liquid ejecting head 1 may have a structure other than the structure symmetrical about the central imaginary plane A10. In FIG. 3, partition walls 63 of a holder 6 to be described later are omitted from the illustration.

As illustrated in any of FIGS. 3 to 5, the liquid ejecting head 1 includes multiple head modules 2, two common channel members 3, seal members 4, multiple sub-holders 5, the holder 6, multiple wiring substrates 7, and a relay substrate 70. In the present embodiment, one sub-holder 5 is provided for each head module 2. As illustrated in FIG. 4, each head module 2 and the corresponding sub-holder 5 form a sub-unit 15.

### 1-3A. Head Module 2

In the example in FIG. 4, the multiple head modules 2 are six head modules 2. The number of head modules 2 is not limited to six, but may be any number of two to five or seven or more.

In the present embodiment, the multiple head modules 2 are next to each other along the X axis. As illustrated in FIGS. 3 and 5, each head module 2 is long along the Y axis. Each head module 2 ejects the ink in the Z1 direction. Each head module 2 includes a chip 20 and a channel orifice forming member 25. The chip 20 is arranged in the Z1 direction relative to the channel orifice forming member 25.

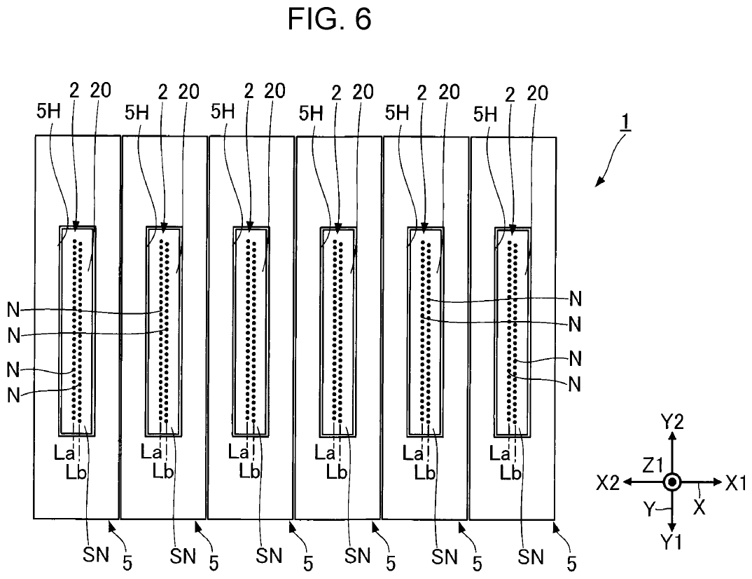

FIG. 6 is an underside view of the liquid ejecting head 1 illustrated in FIG. 3. As illustrated in FIG. 6, each head module 2 includes multiple nozzles N to eject the ink. The multiple nozzles N are arrayed along the Y axis. The multiple nozzles N are divided into a nozzle array La and a nozzle array Lb arranged side by side while being spaced out along the X axis. Each of the nozzle array La and the nozzle array Lb is a set of multiple nozzles N arrayed linearly along the Y axis. A surface of the head module 2 in which the orifices of the multiples nozzles N are formed is referred to as a nozzle surface SN. The nozzle surface SN is a surface of the chip 20 of the head module 2 facing in the Z1 direction. Alternatively, for example, the multiple nozzles N may be arrayed in a direction crossing the X axis and the Y axis as viewed in the Z1 direction.

1-3Aa. Chip 20

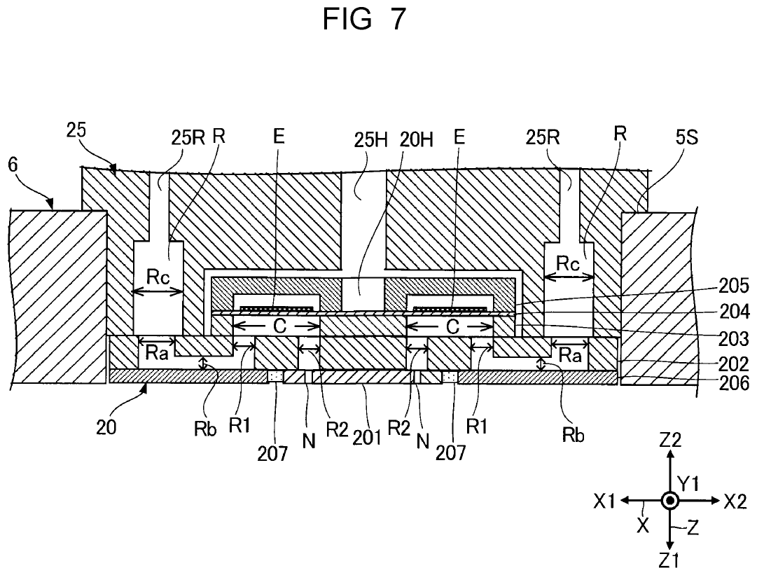

FIG. 7 is a cross-sectional view of the chip 20 included in the head module 2 illustrated in FIG. 4. The chip 20 has a structure in which elements related to the nozzles N of the nozzle array La are arranged in plane symmetry with elements related to the nozzles N of the nozzle array Lb. In the following description, the elements for the nozzle array La will be mainly described and description of the elements for the nozzle array Lb will be omitted if unnecessary. In addition, the nozzle array La and the nozzle array Lb will be referred to as a nozzle array L below if there is no need to distinguish between them.

As illustrated in FIG. 7, the chip 20 of each head module 2 includes, for example, a communication plate 202, a pressure chamber substrate 203, a vibration plate 204, a nozzle plate 201, a cover 206, multiple driver elements E, and a sealing substrate 205.

Each of the communication plate 202, the pressure chamber substrate 203, the vibration plate 204, the nozzle plate 201, and the cover 206 is a plate-shaped member that is long along the Y axis. The pressure chamber substrate 203 is provided on a surface of the communication plate 202 facing in the Z2 direction. The nozzle plate 201 and the cover 206 are provided on a surface of the communication plate 202 facing in the Z1 direction. For example, these members are fixed to each other with an adhesive.

The nozzle plate 201 is a plate-shaped member in which the multiple nozzles N are formed. The nozzle plate 201 is the outermost member in the Z1 direction in the head module 2. A surface of the nozzle plate 201 facing in the Z1 direction serves as the nozzle surface SN. Each of the multiple nozzles N is a circular through hole to eject the ink. For example, the nozzle plate 201 is produced by processing a single crystal substrate of silicon (Si) with semiconductor manufacturing techniques such as photolithography and etching.

In the communication plate 202, multiple narrowed portions R1, multiple communication channels R2, a communication space Ra, and a common channel Rb are formed. Each of the narrowed portions R1 and the communication channels R2 is a through hole extended in the Z1 direction and formed for each nozzle N. The communication channels R2 coincide with the respective nozzles N in the plan view. The communication space Ra is a cavity formed in a shape long along the Y axis. The communication space Ra extends along the Y axis. The common channel Rb communicates with the communication space Ra and overlaps the communication space Ra in the plan view. The common channel Rb extends along the Y axis. The common channel Rb communicates with the multiple narrowed portions R1. The communication space Ra communicates with a space Rc included in the channel orifice forming member 25.

The communication space Ra, the common channel Rb, and the space Rc form a common space R provided in common to the multiple nozzles N. The common space R functions as a reservoir of the ink. The ink stored in the common space R is distributed to the narrowed portions R1 and is supplied to and filled in multiple pressure chambers C concurrently.

In the pressure chamber substrate 203, the multiple pressure chambers C are formed. Each of the pressure chambers C is a space located between the communication plate 202 and the vibration plate 204 and formed by wall surfaces of the pressure chamber substrate 203. One pressure chamber C is formed for each nozzle N. The pressure chamber C is a long space extended in the X1 direction. The multiple pressure chambers C are arrayed along the Y axis.

The communication plate 202 and the pressure chamber substrate 203 are each produced by, for example, processing a semiconductor substrate such as a single crystal substrate of silicon.

The vibration plate 204 elastically deformable is mounted on top of the pressure chamber C. The vibration plate 204 is stacked on the pressure chamber substrate 203 and is in contact with a surface of the pressure chamber substrate 203 opposite to the communication plate 202. The vibration plate 204 is a rectangular plate-shaped member that is long along the Y axis in the plan view. The pressure chamber C communicates with the nozzle N through the communication channel R2 and communicates with the communication space Ra through the narrowed portion R1. Therefore, the pressure chamber C communicates with the nozzle N via the communication channel R2 and communicates with the communication space Ra via the narrowed portion R1. A channel dedicated to each nozzle N is formed by the nozzle N, the communication channel R2, the pressure chamber C, and the narrowed portion R1. For convenience of description, the pressure chamber substrate 203 and the vibration plate 204 are drawn as separate substrates in FIG. 7, but are actually stacked in a single silicon substrate.

The driver element E for each pressure chamber C is formed on a surface of the vibration plate 204 opposite to the pressure chamber C. The driver element E is a piezoelectric element in a shape long along the X axis in the plan view. The driver element E includes, for example, a pair of electrodes and a piezoelectric body provided between the pair of electrodes. Instead, the driver element E may be an electrothermal transducer element to generate thermal energy.

The sealing substrate 205 is a structural body to protect the multiple driver elements E. The sealing substrate 205 is fixed to a surface of the vibration plate 204 with, for example, an adhesive. The multiple driver elements E are stored inside a dented portion formed in a surface of the sealing substrate 205 facing the vibration plate 204. Moreover, a through hole 20H into which the wiring substrate 7 to be described later is to be inserted is provided in the sealing substrate 205.

The cover 206 is a thin metallic plate forming a wall surface of the common channel Rb. The cover 206 has a thickness approximately equal to the thickness of the nozzle plate 201. The planar shape of the cover 206 is, for example, a frame shape surrounding the nozzle plate 201. A mold 207 made of a resin is provided between the cover 206 and the nozzle plate 201. The surface of the cover 206 facing in the Z1 direction constitutes a part of the nozzle surface SN.

In this chip 20, when the driver element E contracts due to energization, the vibration plate 204 is bent and deflected in the direction that reduces the volume of the pressure chamber C, and the pressure in the pressure chamber C increases, causing an ink droplet to be ejected from the nozzle N. In this process, the pressure is also transmitted toward the narrowed portion R1 from the pressure chamber C, and the ink also flows into the common channel Rb through the narrowed portion R1. After ink ejection, the driver element E returns to its original position. At this time, the ink in the region from the nozzle N to the common channel Rb also vibrates. Then, as soon as the meniscus of the nozzle N is restored, the ink is supplied from the narrowed portion R1. Through the above series of operations, the ink is ejected from the nozzle N.

Although the chip 20 in the present embodiment includes all the elements illustrated in FIG. 3, the chip 20 may include only some of the elements or may include additional elements.

The chip 20 has, for example, a monolithic structure, is a member thinner than the channel orifice forming member 25, and is, for example, a component having a thickness of smaller than 3000 μm. The chip 20 may be a component having a thickness of 1500 μm or smaller or 1000 μm or smaller. The thickness of the chip 20 may be ⅕ or smaller of the length of the short side of the chip 20 as viewed in the direction along the Z axis, which is the thickness direction of the chip 20. The chip 20 may include only at least one component among from the nozzle plate 201, the pressure chamber substrate 203, the communication plate 202 or the driver elements E, and the sealing substrate 205. The chip 20 preferably includes at least the nozzle plate 201, more preferably further includes the pressure chamber substrate 203, and particularly preferably further includes the communication plate 202. Furthermore, at least one component among from the nozzle plate 201, the pressure chamber substrate 203, the communication plate 202 or the pressure chamber substrate 203 on which the driver elements E are stacked, and the sealing substrate 205 may be regarded as the chip 20. The chip 20 may be not only a stack of silicon substrates manufactured by MEMS, but also a stack of ceramic sheets or thin plates made of metals or the like, or a stack in which thin plate-shaped members made of the aforementioned materials are stacked.

1-3Ab. Channel Orifice Forming Member 25

As illustrated in FIGS. 5 and 7, the channel orifice forming member 25 is arranged in the Z2 direction relative to the chip 20. The channel orifice forming member 25 and the chip 20 are fixed to each other with, for example, an adhesive. The channel orifice forming member 25 and the chip 20 are aligned with each other with high precision in advance. The channel orifice forming member 25 includes, for example, a channel for supplying the ink to the chip 20.

For example, the channel orifice forming member 25 is preferably a member having a thickness of 3000 μm or greater, more preferably a member having a thickness of 5000 μm or greater, and even more preferably a member having a thickness of 8000 μm or greater. The channel orifice forming member 25 may be formed of a single member or a stack of multiple members. The channel orifice forming member 25 may contain a resin or a metal.

A length of the channel orifice forming member 25 in the direction along the Z axis, that is, the thickness of the channel orifice forming member 25, is greater than a thickness D2 of the chip 20. The thickness of the channel orifice forming member 25 mentioned herein is a thickness at a position coinciding with a seal area 4S to be described later, as viewed in the Z1 direction. In other words, the chip 20 is thinner than the channel orifice forming member 25. In addition, as illustrated in FIG. 5, the channel orifice forming member 25 includes a surface 251 facing in the Z1 direction and a surface 252 facing in the Z2 direction.

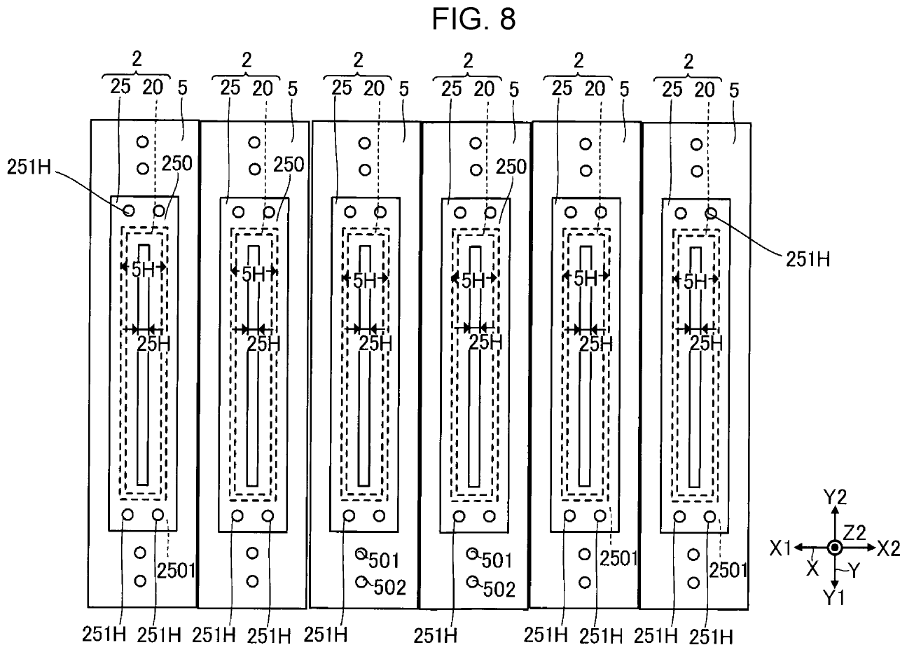

FIG. 8 is a topside view of the channel orifice forming members 25 of the head modules 2 illustrated in FIG. 5. As illustrated in FIG. 8, the planar shape of the channel orifice forming member 25 is larger than the planar shape of the chip 20. In other words, as viewed in the Z1 direction, the chip 20 is smaller in outer profile than the channel orifice forming member 25. As viewed in the Z1 direction, the channel orifice forming member 25 is arranged so as to overlap the chip 20 and cover the chip 20.

As illustrated in FIGS. 5 and 8, the channel orifice forming member 25 includes a flange portion 250 to be fixed to the sub-holder 5 to be described later. The planar shape of the flange portion 250 is a rectangular frame shape surrounding an opening 5H of the sub-holder 5 to be described later. A surface of the flange portion 250 facing in the Z1 direction is a supported surface 2511 supported by the sub-holder 5 to be described later. Since the planar shape of the flange portion 250 is the rectangular frame shape surrounding the opening 5H, the planar shape of the supported surface 2511 is similarly a rectangular frame shape surrounding the opening 5H. As illustrated in FIG. 8, the supported surface 2511 is located in the Z2 direction relative to the chip 20. Accordingly, the supported surface 2511 is located in the Z2 direction relative to the nozzle plate 201.

In addition, as illustrated in FIG. 8, a through hole 25H is provided to the channel orifice forming member 25. The wiring substrate 7 to be described later is to be inserted into the through hole 25H. The through hole 25H is provided at a central portion of the channel orifice forming member 25 in the plan view. The through hole 25H coincides with the through hole 20H of the sealing substrate 205 in the plan view.

As illustrated in FIGS. 5 and 7, a channel 25R is formed inside the channel orifice forming member 25. The channel 25R is provided to supply the ink to the chip 20. As illustrated in FIG. 7, the space Rc is formed on the chip 20 side of the channel 25R, that is, downstream of the channel 25R. The channel 25R and the space Rc communicate with each other.

As illustrated in FIG. 5, multiple channel orifices 251H are provided on the side of the channel 25R of the channel orifice forming member 25, the side opposite to the chip 20, that is, the upstream side of the channel 25R. Each of the channel orifices 251H is a cavity end of the channel 25R in the Z2 direction. As illustrated in FIGS. 5 and 8, the multiple channel orifices 251H are provided in the flange portion 250 of the channel orifice forming member 25. The channel orifices 251H are arranged outside the chip 20 as viewed in the Z1 direction. In the present embodiment, two channel orifices 251H are provided for each nozzle array L.

1-3B. Common channel member 3

As illustrated in FIGS. 3 to 5, the common channel members 3 are arranged in the Z2 direction relative to the multiple head modules 2. Each common channel member 3 includes a single channel 3R. The channel 3R supplies the ink to the head modules 2 and distributes the ink to the head modules 2. The channel 3R is a common channel provided in common to the multiple head modules 2. The common channel member 3 is also a supply channel member to supply the ink to the head modules 2, and includes a common portion 3RA extended along the X axis and multiple branched portions 3RB branched off from the common portion 3RA and extended in the Z1 direction. Although not illustrated, the common channel member 3 is provided with a channel joint for connecting to a supply channel outside the liquid ejecting head 1 in order that the common channel member 3 can communicate with the liquid reservoir section 9. This channel joint not illustrated is exposed to outside of the liquid ejecting head 1 through, for example, a not-illustrated opening formed in the holder 6.

Instead, the common channel member 3 may include multiple channels 3R communicating with the multiple head modules 2. Specifically, instead of the channel 3R including the common portion 3RA communicating with the multiple head modules 2, the common channel member 3 may include the multiple channels 3R communicating with the respective multiple head modules 2.

As illustrated in FIG. 5, channel orifices 31H are provided on the head module 2 side of each channel 3R, that is, the downstream side of the channel 3R. Each channel orifice 31H is a cavity end of the channel 3R in the Z1 direction. The channel orifices 31H are provided corresponding to the foregoing channel orifices 251H.

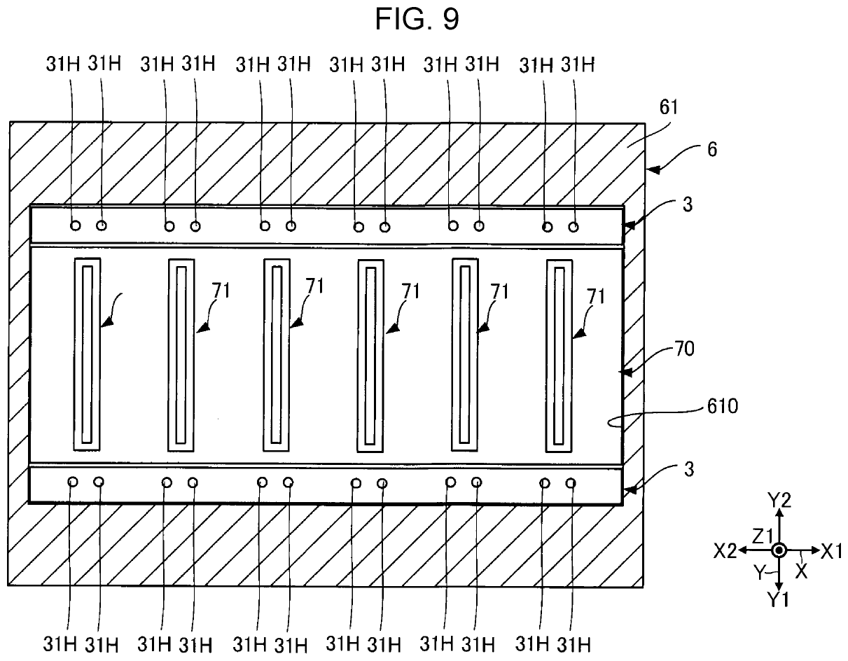

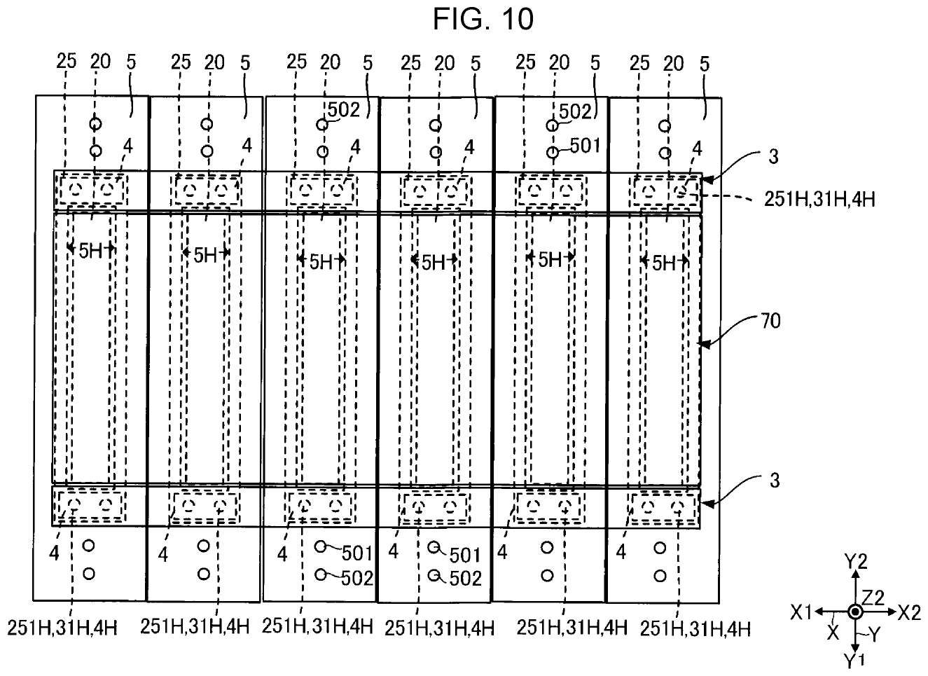

FIG. 9 is an underside view of the common channel members 3 illustrated in FIG. 5. FIG. 10 is a topside view of the common channel members 3 illustrated in FIG. 5. As illustrated in FIGS. 9 and 10, each common channel member 3 is a long member extended in the X axis direction. As illustrated in FIG. 9, the two common channel members 3 are arranged inside the dented portion 610 of the holder 6 to be described later. The two common channel members 3 are arranged so as to sandwich the relay substrate 70 to be described later as viewed in the Z2 direction. The multiple channel orifices 31H included in each of the common channel members 3 are spaced out from each other and arrayed along the X axis.

As illustrated in FIG. 10, each common channel member 3 overlaps the multiple head modules 2 as viewed in the Z1 direction. Each common channel member 3 is provided in common to the multiple head modules 2. Specifically, as viewed in the Z1 direction, each common channel member 3 overlaps the flange portions 250 of the multiple channel orifice forming members 25. As viewed in the Z1 direction, the multiple channel orifices 31H coincide with the foregoing multiple channel orifices 251H on a one-to-one basis. In addition, each common channel member 3 is arranged at a position different from the multiple chips 20 so as not to overlap the chips 20 as viewed in the Z1 direction. As viewed in the Z1 direction, each common channel member 3 overlaps some of the multiple seal members 4 to be described below.

### 1-3C. Seal Member 4

As illustrated in FIGS. 3 to 5, the seal members 4 are provided between the head modules 2 and the common channel members 3 in the Z1 direction. The seal members 4 are provided for each head module 2. The seal members 4 are elastic. The seal members 4 are made of an elastic material such as elastomer, for example. In the present embodiment, the length of the seal member 4 along the Z axis, that is, the thickness of the seal member 4, is constant. The thickness of the seal member 4 is smaller than the thicknesses of the channel orifice forming member 25 and the common channel member 3. The seal member 4 is squeezed between the head module 2 and the common channel member 3.

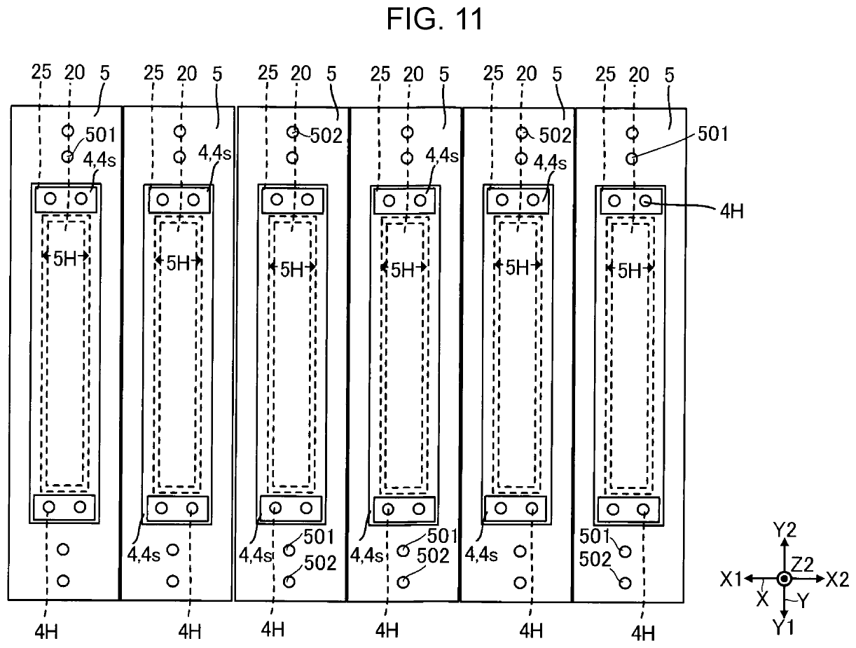

FIG. 11 is a topside view of the seal members 4 illustrated in FIG. 5. In the example illustrated in FIG. 11, two seal members 4 are provided for each head module 2. The two seal members 4 are provided at both longitudinal ends of one head module 2. Each seal member 4 has a rectangular shape as viewed in the Z1 direction. Each seal member 4 overlaps the flange portion 250 included in the channel orifice forming member 25 of the head module 2 as viewed in the Z1 direction. On the other hand, in the present embodiment, the seal members 4 are provided at positions different from the chips 20 as viewed in the Z1 direction. In other words, the seal members 4 do not overlap the chips 20 as viewed in the Z1 direction.

As illustrated in FIGS. 5 and 11, each seal member 4 includes two communication orifices 4H. As illustrated in FIG. 5, each communication orifice 4H is provided corresponding to one of the channel orifices 251H of the channel orifice forming members 25 and one of the channel orifices 31H of the common channel members 3. As illustrated in FIG. 11, the communication orifice 4H coincides with both the channel orifice 31H and the channel orifice 251H as viewed in the Z1 direction. As illustrated in FIG. 5, the communication orifice 4H is connected to the channel 25R via the channel orifice 251H. The communication orifice 4H is connected to the channel 3R via the channel orifice 31H. Thus, the channel 25R and the channel 3R communicate with each other through the communication orifice 4H. Specifically, the channel 25R and the channel 3R communicate with each other through the communication orifice 4H with the seal member 4 squeezed between the channel orifice forming member 25 and the common channel member 3.

The seal member 4 including such communication orifices 4H is a member for liquid-tightly connecting the channel orifices 251H of the head module 2 and the channel orifices 31H of the common channel member 3. The ink flowing in the channels 3R of the common channel members 3 flows into the channels 25R of the channel orifice forming members 25 via the communication orifices 4H and is supplied to the dedicated channels included in the chips 20 via the common spaces R.

As illustrated in FIG. 11, the seal member 4 has a seal area 4S. In the present embodiment, the entire area of the seal member 4 serves as the seal area 4S. The seal area 4S is an area of the seal member 4 that is in contact with both the channel orifice forming member 25 and the common channel member 3 and is held between the channel orifice forming member 25 and the common channel member 3. The seal area 4S is an area squeezed with application of a load from the channel orifice forming member 25 and the common channel member 3 so as to liquid-tightly connect the channel orifices 251H and the channel orifices 31H. In other words, even an area of the seal member 4 located between the channel orifice forming member 25 and the common channel member 3 is not included in the seal area 4S if the area is not squeezed with application of the load from both members, and does not actually contribute to the liquid-tight connection between the channel orifice 251H and the channel orifice 31H.

As illustrated in FIG. 11, the seal members 4 are provided at the positions different from the chips 20 as viewed in the Z1 direction, and accordingly the seal areas 4S are provided at the positions different the chips 20 as viewed in the Z1 direction. In other words, the seal areas 4S do not overlap the chip 20 as viewed in the Z1 direction. Since the seal areas 4S do not overlap the chips 20 as viewed in the Z1 direction, the reaction force of the seal members 4 is less likely to act on the chips 20 than if they overlap the chips 20. As a result, the reliability of the head modules 2 can be improved.

As described above, the channel 25R and the channel 3R communicate with each other through the communication orifice 4H with the seal member 4 squeezed between the channel orifice forming member 25 and the common channel member 3. The reaction force of the squeezed seal member 4 may apply stress to the chip 20, and cause warping or the like of the chip 20. In this way, if the reaction force of the seal member 4 acts on the chip 20, the reliability of the head module 2 may deteriorate due to the occurrence of an undesirable phenomenon such, for example, as displacement of the nozzles N as a result of deformation of the nozzle plate 201, a change in ejection characteristics as a result of deformation of the pressure chamber substrate 203 and the communication plate 202, or a breakage of any of members constituting the chip 20 if the members include a silicon substrate or ceramic sheet.

In the present embodiment, the seal areas 4S of the seal members 4 do not overlap the chips 20 as viewed in the Z1 direction. For this reason, it is possible to keep the reaction force of the seal members 4 from acting on the chips 20 while keeping the sealing performance of the seal members 4 from decreasing. Thus, the reliability of the head modules 2 can be improved.

As illustrated in FIG. 10, none of the communication orifices 4H, the channel orifices 251H, and the channel orifices 31H overlaps the chips 20 as viewed in the Z1 direction. All of the communication orifices 4H, the channel orifices 251H, and the channel orifices 31H are arranged outside the chips 20 as viewed in the Z1 direction. Specifically, the communication orifices 4H and the channel orifices 251H and 31H are arranged on both longitudinal sides of each chip 20 as viewed in the Z1 direction. For this reason, the seal areas 4S of the seal members 4 which liquid-tightly seal the channels 25R and 3R as described above can be arranged outside the chips 20. Accordingly, as described above, the reaction force of the seal members 4 can be kept from affecting the chips 20.

In addition, each of the seal areas 4S is arranged in the Y1 direction or the Y2 direction, which is a longitudinal direction of the head module 2, relative to the chip 20 as viewed in the Z1 direction. Since the seal areas 4S are arranged in the longitudinal directions relative to the chips 20, none of the seal areas 4S is arranged between the adjacent chips 20. This can avoid an increase in the distance between the adjacent chips 20 due to the seal area 4S if provided. For this reason, the print quality is less likely to be affected.

However, the seal areas 4S may be arranged, relative to the chips 20, in directions in which the multiple head modules 2 are arrayed, that is, the short side directions of the head modules 2. The seal members 4 may be provided, relative to the chips 20, in the directions in which the multiple head modules 2 are arrayed, that is, the short-side directions of the head modules 2.

### 1-3D. Sub-Holder 5

The sub-holder 5 illustrated in FIGS. 4 to 6 is a member that supports each head module 2. The sub-holders 5 are provided for the head modules 2 on a one-to-one basis. The sub-holder 5 is a plate-shaped member that is long along the Y axis while a thickness direction thereof is a direction along the Z axis. The sub-holder 5 is arranged in the Z1 direction relative to the channel orifice forming member 25. The sub-holder 5 is a member that sandwiches the seal members 4 and the channel orifice forming member 25 between itself and the common channel members 3. As illustrated in FIG. 5, the sub-holder 5 includes a surface 511 facing in the Z1 direction and a surface 512 facing in the Z2 direction. The sub-holder 5 is a member that does not include any channel through which the ink flows.

Each sub-holder 5 and the corresponding head module 2 are fixed to each other with an adhesive. The sub-holder 5 and the head module 2 are fixed in such a relative position that the sub-holder 5 and the nozzles N of the nozzle plate 201 are aligned with each other with high precision. The sub-unit 15 including each sub-holder 5 is fixed to the holder 6 to be described later in a detachably-attached manner. Specifically, the sub-holder 5 is not bonded with an adhesive or the like. For this reason, the sub-units 15 are replaceable on a per-sub-unit 15 basis. The sub-holder 5 and the head module 2 are fixed to each other with an adhesive.

For this reason, for example, in the case where one or some of the multiple head modules 2 included in the head unit 10 are broken, the sub-units 15 including the broken head modules 2 are replaced with other sub-units 15 including unbroken head modules 2, so that the liquid ejecting head 1 can be recycled.

Further, the channel-forming connections between the head module 2 and the common channel members 3 described above are not made with an adhesive, but are made with the seal members 4. For this reason, in the above-described replacement of the head module 2, the channel-forming connections between the head module 2 and the common channel members 3 can be disconnected easily. This facilitates the replacement of the head module 2.

Here, it is preferable to fix each sub-holder 5 and the corresponding head module 2 to each other with an adhesive, but the head module 2 may be configured to be detachable from the sub-holder 5 with decomposition of the adhesive.

The sub-holder 5 is made of, for example, a metal. For example, the sub-holder 5 is made of a metal such as aluminum or stainless steel. The sub-holder 5 has stiffness sufficient to support the head module 2.

The sub-holder 5 is provided with the opening 5H. The opening 5H is a hole passing through the sub-holder 5 in the thickness direction. The opening 5H is provided for exposing a part of the head module 2 to the outside. Specifically, as illustrated in FIG. 6, the chip 20 is exposed from the opening 5H. Accordingly, the multiple nozzles N are exposed from the opening 5H.

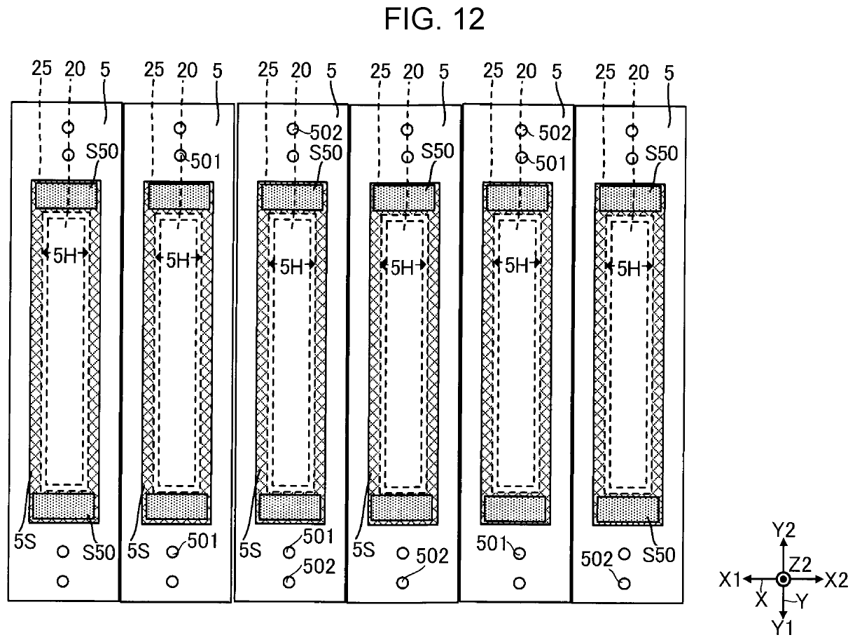

FIG. 12 is a topside view of the sub-holders 5 illustrated in FIG. 5. As illustrated in FIGS. 5 and 12, the sub-holder 5 includes a support surface 5S. The support surface 5S is a part of the surface 512 of the sub-holder 5 facing in the Z2 direction. In FIG. 12, the support surfaces 5S are hatched for facilitating understanding. In the example of FIG. 12, each support surface 5S has a rectangular frame shape as viewed in the Z1 direction.

As illustrated in FIG. 5, the support surface 5S is an area that is in contact with the channel orifice forming member 25 and directly supports the channel orifice forming member 25. The support surface 5S is in contact with the supported surface 2511 of the channel orifice forming member 25. As illustrated in FIG. 12, the support surface 5S includes areas S50 coinciding with the seal areas 4S as viewed in the Z1 direction.

Since the support surface 5S includes the areas S50 coinciding with the seal areas 4S as viewed in the Z1 direction, the sub-holder 5 vertically receives the reaction force of the seal members 4. Therefore, the sub-holder 5 can firmly support the seal areas 4S of the seal members 4 between itself and the common channel members 3. Accordingly, the sub-holder 5 can particularly effectively alleviate the reaction force of the seal members 4.

Moreover, a part of the above-described surface 251 of the channel orifice forming member 25 facing in the Z1 direction includes the supported surface 2511. The supported surface 2511 is supported by being in contact with the sub-holder 5 while surrounding the opening 5H of the sub-holder 5 as viewed in the Z1 direction. Specifically, as described above, the flange portion 250 of the channel orifice forming member 25 includes the supported surface 2511, and the head module 2 is held by the sub-holder 5 with the supported surface 2511 put in contact with the support surface 5S of the sub-holder 5. When the channel orifice forming member 25 is supported by the sub-holder 5 as described above, the load of the seal members 4 can be distributed. As a result, the channel orifice forming member 25 can be made less likely to be broken.

Here, the contact between the supported surface 2511 and the support surface 5S means not only a direct contact between them and but also a connection between them via an adhesive, an elastic bushing, or the like. Accordingly, the channel orifice forming member 25 may be in direct contact with the sub-holder 5 or may be in indirect contact with the sub-holder 5 via another member such as an adhesive or a bushing. The flange portion 250 may have a shape other than the rectangular frame shape in the plan view. For example, the flange portions 250 in rectangular shapes may be provided in both of the Y1 and Y2 directions relative to the opening 5H in the plan view.

Moreover, as illustrated in FIG. 5, the thickness D5 of the sub-holder 5 in the Z1 direction is greater than the thickness D2 of the chip 20 in the Z1 direction. This can reduce a risk of the sub-holder 5 being deformed due to the reaction force of the seal members 4.

The thickness D5 of the sub-holder 5 is preferably two or more times and more preferably three or more times greater than the thickness D2 of the chip 20. This can further reduce the risk of the sub-holder 5 being deformed due to the reaction force of the seal members 4. However, the thickness D5 may be equal to or smaller than the thickness D2.

From the same viewpoint, the thickness D5 of the sub-holder 5 is preferably 1 mm or greater and more preferably 2 mm or greater. In order to further enhance the strength of the sub-holder 5, the thickness D5 may be 3 mm or greater, 5 mm or greater, or 6 mm or greater. On the other hand, from the viewpoint of an increase in the distance between the medium 90 and the nozzle surface SN, that is, a paper gap, the thickness D5 of the sub-holder 5 is preferably 10 mm or smaller, and more preferably 7 mm or smaller.

As illustrated in FIG. 5, in addition to the chip 20, the part of the channel orifice forming member 25 is arranged in the opening 5H of the sub-holder 5. In other words, the part of the channel orifice forming member 25 is inserted in the opening 5H of the sub-holder 5. In the case where the sub-holder 5 exists, the paper gap may increase depending on how great the thickness D5 of the sub-holder 5 is. Specifically, if the thickness D5 of the sub-holder 5 is excessively great, the surface of the chip 20 facing in the Z1 direction may be retracted in the Z2 direction from the surface of the sub-holder 5 facing in the Z1 direction. The increase in the above distance may result in a decrease in the accuracy of ink impact positions on the medium 90.

In the present embodiment, as described above, in addition to the chip 20, the part of the channel orifice forming member 25 is arranged in the opening 5H. Thus, even if the thickness D5 of the sub-holder 5 is increased in order to further enhance the strength of the sub-holder 5, the paper gap may be prevented from increasing.

Further, the surface of the nozzle plate 201 facing in the Z1 direction, namely, the nozzle surface SN, in the chip 20 is approximately flush with the surface 511 of the sub-holder 5 facing in the Z1 direction. In other words, the nozzle surface SN and the surface 511 of the sub-holder 5 facing in the Z1 direction are located at the same Z-axial position. In this case, the paper gap can be kept from increasing as compared with the case where the nozzle surface SN is retracted in the Z2 direction from the surface 511 of the sub-holder 5 facing in the Z1 direction. Moreover, it is easy to collectively wipe the surface 511 of the sub-holder 5 facing in the Z1 direction and the nozzle surface SN.

The nozzle surface SN and the surface 511 of the sub-holder 5 facing in the Z1 direction being approximately flush with each other means not only a case where they are completely flush with each other, but also a case where they have a step formed in between to the extent including a manufacturing error or the like.

Instead, the nozzle surface SN and the surface 511 of the sub-holder 5 facing in the Z1 direction do not have to be approximately flush with each other. The nozzle surface SN and the surface 511 of the sub-holder 5 facing in the Z1 direction may be located at different Z-axial positions or may have a step formed in between. In this case, from the viewpoint of ease of wiping, the distance between the nozzle surface SN and the surface 511 of the sub-holder 5 facing in the Z1 direction is preferably 100 μm or smaller and preferably 50 μm or smaller.

The sub-holder 5 described above is fixed to the holder 6 to be described later in a detachably-attached manner. For example, when the sub-holder 5 is detached from the holder 6, the head module 2 and the wiring substrate 7 to be described later are detached together with the sub-holder 5 from the holder 6. The liquid ejecting head 1 in the present embodiment is configured such that the precision of alignment of the multiple head modules 2 may not decrease in the case where each head module 2 is detached from and reattached to the holder 6.

As illustrated in FIGS. 5 and 12, each sub-holder 5 has two first alignment portions 502 and two first fixing slots 501. The first alignment portions 502 are used for the purpose of positioning the sub-holder 5 with respect to the holder 6 or other purposes. The first fixing slots 501 are used for fixing the sub-holder 5 to the holder 6.

The first alignment portions 502 are provided in the surface 512 of the sub-holder 5 facing in the Z2 direction. In the present embodiment, the first alignment portions 502 are bottomed slots opened in the surface 512 of the sub-holder 5 facing in the Z2 direction. Each first alignment portion 502 is a dented portion provided in the surface 512 of the sub-holder 5 facing in the Z2 direction and may be regarded as a recess formed in the surface 512. The two first alignment portions 502 are provided on both sides of the opening 5H in the longitudinal direction of the sub-holder 5. One of the two first alignment portions 502 is located in the Y1 direction relative to the opening 5H, whereas the other is located in the Y2 direction relative to the opening 5H.

The first fixing slots 501 are provided in the surface 512 of the sub-holder 5 facing in the Z2 direction. The first fixing slots 501 are bottomed slots provided in the surface 512 of the sub-holder 5 facing in the Z2 direction. Each first fixing slot 501 is a dented portion provided in the surface 512 of the sub-holder 5 facing in the Z2 direction and may be regarded as a recess formed in the surface 511. The two first fixing slots 501 are provided on both sides of the opening 5H in the longitudinal direction of the sub-holder 5. One of the two first fixing slots 501 is located in the Y1 direction relative to the opening 5H, whereas the other is located in the Y2 direction relative to the opening 5H.

Each of the first fixing slots 501 is provided away from the corresponding first alignment portion 502 and the opening 5H. Each first fixing slot 501 located in the Y1 direction relative to the opening 5H is closer to the opening 5H than the first alignment portion 502 located in the Y1 direction relative to the opening 5H is. Similarly, each first fixing slot 501 located in the Y2 direction relative to the opening 5H is closer to the opening 5H than the first alignment portion 502 located in the Y2 direction relative to the opening 5H is. The first alignment portions 502, the first fixing slots 501, and the opening 5H are arranged along the longitudinal direction of the sub-holder 5.

The minimum distance between the first fixing slot 501 and the opening 5H is shorter than the minimum distance between the first alignment portion 502 and the opening 5H, but may be longer than the latter distance. Further, the first alignment portions 502, the first fixing slots 501, and the opening 5H do not have to be arranged along the longitudinal direction of the sub-holder 5. For example, the first alignment portions 502 may be provided on both sides of the opening 5H along the X axis.

### 1-3E. Holder 6

As illustrated in FIGS. 3 to 5, the holder 6 is a case where to store the multiple head modules 2 and the common channel members 3. The holder 6 has a box shape having a dented portion 610 opened in the Z1 direction. The multiple head modules 2 and the common channel members 3 are arranged in a storage space in the dented portion 610 of the holder 6. To put it differently, the holder 6 and the multiple sub-holders 5 form the storage space for storing the module head modules 2 and the common channel members 3.

The relay substrate 70 is arranged on a bottom surface of the dented portion 610 of the holder 6. The bottom surface is a surface of the dented portion 610 of the holder 6 facing in the Z1 direction. The holder 6 is made of a metal such, for example, as aluminum or stainless steel. Although not illustrated in detail, the holder 6 is provided with an opening to which a wiring member outside the liquid ejecting head 1 for electrically connecting the relay substrate 70 to the control unit 91 is to be inserted.

The holder 6 includes a flat plate portion 61, a sidewall 62, multiple partition walls 63, and two flange portions 64. The flat plate portion 61, the sidewall 62, the multiple partition walls 63, and the two flange portions 64 are formed integrally. The flat plate portion 61 is a flat plate-shaped portion along an X-Y plane. The flat plate portion 61 is located in the Z2 direction relative to the common channel members 3. The sidewall 62 is a portion extended in the Z1 direction from an outer edge of the flat plate portion 61. A planar shape of the sidewall 62 is a rectangular frame shape. The multiple partition walls 63 are arranged between the multiple head modules 2. Each partition wall 63 extends along the Y axis. The partition walls 63 and the head modules 2 are alternately arranged along the X axis.

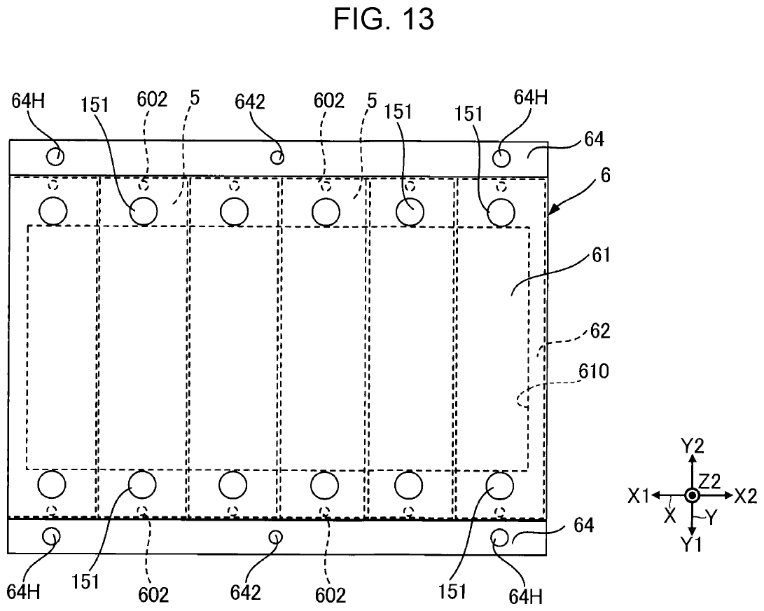

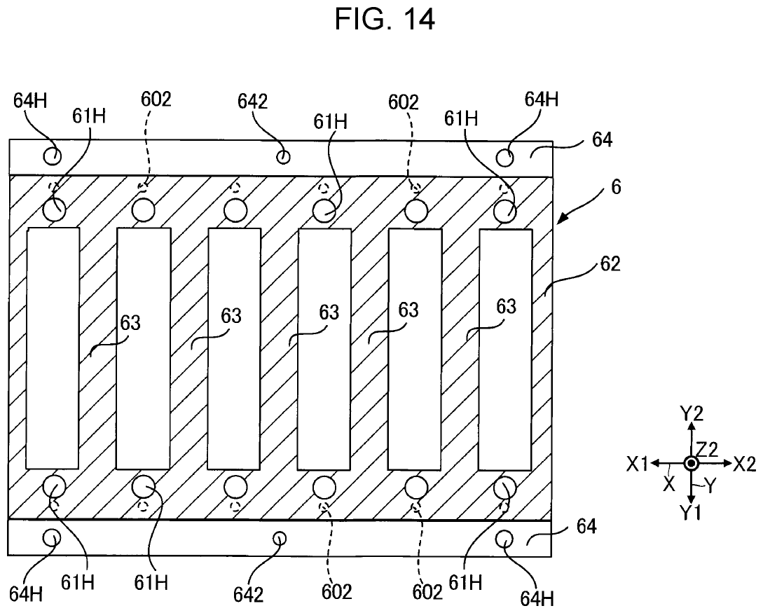

FIG. 13 is a topside view of an upper portion of the holder 6 illustrated in FIG. 5. FIG. 14 is a view illustrating a lower portion of the holder 6 illustrated in FIG. 5. As illustrated in FIGS. 4 and 13, the multiple partition walls 63 are not provided in the upper portion of the holder 6. In contrast, as illustrated in FIGS. 4 and 14, the multiple partition walls 63 are provided in the lower portion of the holder 6. A portion of the holder 6 provided with the multiple partition walls 63 may be regarded as the lower portion of the holder 6, whereas a portion of the holder 6 not provided with the multiple partition walls 63 may be regarded as the upper portion of the holder 6.

As illustrated in FIG. 4, the multiple partition walls 63 exist in an area where the multiple head modules 2 are provided. The multiple partition walls 63 are located in the Z1 direction relative to the Z-axial center of the holder 6. A portion of the holder 6 extended in the Z2 direction from the Z-axial center is not provided with the multiple partition walls 63 so as to allow the common channel members 3 arranged therein.

As illustrated in FIGS. 5 and 14, for each sub-holder 5, the holder 6 includes two second alignment portions 602 and two first fixing holes 61H. As described above, the sub-holder 5 can be detachably attached to the holder 6. The second alignment portions 602 are used for the purpose of positioning the sub-holder 5 with respect to the holder 6 or other purposes. The first fixing holes 61H are used to fix the sub-holder 5 to the holder 6.

The second alignment portions 602 are provided in a surface 605 of the holder 6 facing in the Z1 direction. In the present embodiment, the second alignment portions 602 are protrusions protruding in the Z1 direction from the surface 605 of the holder 6 facing in the Z1 direction. As illustrated in FIG. 13, each second alignment portions 602 is provided in the Y1 direction or the Y2 direction relative to the dented portion 610 as viewed in the Z1 direction. The two second alignment portions 602 are provided corresponding to the foregoing two first alignment portions 502 and coincide with the first alignment portions 502 as viewed in the Z1 direction. Accordingly, the multiple second alignment portions 602 are provided for the multiple first alignment portions 502 on a one-to-one basis.

Each first fixing hole 61H is a hole passing through the holder 6 in the Z1 direction. Each first fixing hole 61H is provided in the Y1 direction or the Y2 direction relative to the dented portion 610 as viewed in the Z1 direction. The two first fixing holes 61H are provided corresponding to the foregoing two first fixing slots 501 and coincide with the two first fixing slots 501 as viewed in the Z1 direction.

Each first fixing hole 61H located in the Y1 direction relative to the dented portion 610 is closer to the dented portion 610 than the second alignment portion 602 located in the Y1 direction relative to the dented portion 610 is. Similarly, each first fixing hole 61H located in the Y2 direction relative to the dented portion 610 is closer to the dented portion 610 than the first alignment portion 502 located in the Y2 direction relative to the dented portion 610 is. Each first fixing hole 61H and its adjacent second alignment portion 602 are spaced out and arranged along the Y axis.

The minimum distance between the first fixing hole 61H and the dented portion 610 is shorter than the minimum distance between the second alignment portion 602 and the dented portion 610, but may be longer than the latter distance. Further, the second alignment portion 602 and the first fixing hole 61H do not have to be arranged along the longitudinal direction of the sub-holder 5.

The second alignment portions 602 are press-fitted into the foregoing first alignment portions 502 to position the sub-holder 5 with respect to the holder 6. The first alignment portions 502 and the second alignment portions 602 are provided on a per-sub-holder 5 basis, in other words, for each head module 2 held by the sub-holder 5.

The provision of the first alignment portions 502 and the second alignment portions 602 described above enables easy positioning for attaching each sub-holder 5 to the holder 6. Moreover, since the first alignment portions 502 and the second alignment portions 602 are provided on the per-sub-holder 5 basis, the alignment of the multiple sub-holders 5 with the holder 6 can be made with high precision.

As described above, each sub-holder 5 holds the head module 2. Accordingly, the provision of the first alignment portions 502 and the second alignment portions 602 enables each head module 2 fixed to the sub-holder 5 to be positioned with respect to the holder 6. Further, since the first alignment portions 502 and the second alignment portions 602 are provided on the per-sub-holder 5 basis, the alignment of the multiple head modules 2 with the holder 6 can be made with high precision. That is, the alignment of the multiple head modules 2 with the holder 6 can be made on the per-sub-holder 5 basis. For this reason, in order to replace only some of the multiple head modules 2, there is no need to realign all the head modules 2.

Moreover, the multiple head modules 2 can be aligned with each other with high precision in the simple method including press-fitting the second alignment portions 602 into the first alignment portions 502. This allows only a desired head module 2 to be replaced easily among the multiple head module 2. Since each of the head modules 2 can be replaced as described above, the liquid ejecting head 1 is easy to repair.

Here, a press-fit refers to a tight fit or a transition fit. A press-fit state is defined as a state where each first alignment portion 502 is in contact with the corresponding second alignment portion 602 in at least two or more points, when the first alignment portion 502 is completely inserted into the second alignment portion 602. As viewed in the direction along the Z axis, before a press-fit, the length of the longest line segment connecting two points on the outer circumference of the second alignment portion 602 serving as an alignment pin is greater than the diameter of the largest circle inscribed in the first alignment portion 502 serving as an alignment slot. Moreover, in the press-fit state, the head module 2 is fitted to the holder 6 to such an extent that a force applied by the press-fit may prevent the head module 2 from falling down due to its own weight.

The multiple second alignment portions 602 are arranged on the surface 605 of the holder 6 facing in the Z1 direction. As described above, the first alignment portions 502 are arranged in the surface 512 of the sub-holder 5 facing in the Z2 direction opposite to the Z1 direction. Then, each head module 2 is supported by the surface 512 of the sub-holder 5 facing in the Z2 direction.

The arrangement of the first alignment portions 502, the second alignment portions 602, and the head module 2 as described above enables easy attachment and detachment from below the holder 6 for replacing only the sub-unit 15 including the sub-holder 5 and the head module 2 as a replacement target. In order to attach a sub-unit 15 to the holder 6 again as a replacement for a sub-unit 15 of a replacement target, it is only necessary to make the channel-forming connections between the head module 2 as the replacement and the common channel members 3, and to electrically connect the wiring substrate 7 attached to the head module 2 as the replacement to the relay substrate 70. Therefore, there is no need to make the channel-forming connections between the head modules 2 other than the replacement target and the common channel members 3, and to electrically connect their wiring substrates 7 to the relay substrate 70. Thus, the attachment and detachment work for repairing the liquid ejecting head 1 can be simplified.

Here, the surface 512 may be stepped such that the surface 512 in which first alignment portions 502 are arranged and the surface 512 that supports the head module 2 are located at different positions in the direction along the Z axis.

Moreover, the common channel members 3 and the wiring substrates 7 are arranged on the bottom surface of the dented portion 610 of the holder 6 and the sub-holders 5 holding the head modules 2 are arranged so as to cover the opening of the dented portion 610. This makes it easy to shorten the distance between the head modules 2 and the common channel members 3, and also makes it easy to shorten the length of the wiring substrates 7.

In the present embodiment, the first alignment portions 502 are the bottomed slots provided in the surface of the sub-holder 5 facing in the Z2 direction and recessed in the Z1 direction as described above. For this reason, the first alignment portions 502 are not exposed to the outside of the sub-holder 5. For example, the first alignment portions 502 are not provided in the surface of the sub-holder 5 facing in the Z1 direction. Therefore, it is possible to prevent mist or the like of the ink ejected from the nozzles N from adhering to the first alignment portions 502.

The above-described common channel members 3 are arranged in the Z2 direction relative to the multiple head modules 2, and overlap the multiple head modules 2 as viewed in the Z1 direction. In the structure in which the multiple head modules 2 are arranged below the common channel members 3, the first alignment portions 502 are provided in the surface of the sub-holder 5 facing in the Z2 direction. This structure enables easy attachment and detachment for only a sub-unit 15 of a replacement target from below the holder 6 and the common channel members 3. Therefore, there is no need to disconnect the channel-forming connections between the sub-units 15 other than the replacement target and the common channel members 3, which simplifies the attachment and detachment work.

Here, the holder 6 and the common channel members 3 are separate members but may be integrated. Instead, a part of each of the common channel members 3 may be a part of the holder 6.

A first fixing member 151 is inserted into the first fixing hole 61H and the first fixing slot 501. The sub-holder 5 is fixed to the holder 6 with the first fixing members 151. As illustrated in FIGS. 3 and 13, the first fixing members 151 are provided on a per-sub-holder 5 basis. In the present embodiment, two first fixing members 151 are provided for one sub-holder 5.

The multiple first fixing members 151 fix each of the multiple sub-holders 5 to the holder 6 in a detachably-attached manner. Thus, the first fixing members 151 can be considered to fix each of the head modules 2 to the common channel members 3 by fixing the corresponding sub-holder 5 to the holder 6.

Specifically, each first fixing member 151 is inserted in the Z1 direction into the first fixing hole 61H as a through hole and the first fixing slot 501 as a recess in this order. Thus, a part of the first fixing member 151 is exposed from a surface 606 of the holder 6 facing in the Z2 direction, but the first fixing member 151 is not exposed from the surface 511 of the sub-holder 5 facing in the Z1 direction. Thus, the first fixing member 151 is protected from adhesion and solidification of ink mist. This makes it possible to prevent the first fixing member 151 from becoming difficult to remove from the holder 6 and the sub-holder 5 due to the adhesion of the mist.

The depth D61 of the first fixing hole 61H is greater than the depth D51 of the first fixing slot 501. Each of the first fixing hole 61H and the first fixing slot 501 is formed along the Z1 direction. The depths D61 and D51 are defined as depths along the Z1 direction.

The sub-unit 15 is small in size and difficult for some user to grasp. The depth D61 of the first fixing hole 61H is greater than the depth D51 of the first fixing slot 501, in other words, the depth D51 of the first fixing slot 501 is smaller than the depth D61 of the first fixing hole 61H, so that even if the sub-unit 15 is difficult to grasp, the press-fit of the sub-unit 15 in the holder 6 can be easily released.

For example, after the first fixing members 151 are removed from the first fixing holes 61H, long rod-shaped members are inserted into the first fixing holes 61H and the sub-holder 5 is pressed in the Z1 direction by these members. As a result, the press-fit of the sub-holder 5 in the holder 6 can be released easily. The use of the first fixing holes 61H as holes for releasing the press-fit makes it possible to easily release the press-fit of the sub-holder 5 in the holder 6. In the case where the depth D6 of the holder 6 is greater than the depth D5 of the sub-holder 5, the sub-holder 5 can be more easily detached from the holder 6 than in the case where the depth D6 is smaller than the depth D5.

A distance L51 from the bottom surface of the first fixing slot 501 to the surface 511 of the sub-holder 5 facing in the Z1 direction is greater than the depth D51 of the first fixing slot 501. In the case where the distance L51 is greater than the depth D51, the sub-holder 5 is less likely to be deformed in the process of releasing the press-fit of the sub-holder 5 in the holder 6 than in the case where the distance L51 is smaller than the depth D51.

However, the distance L51 may be smaller than the depth D51. In this case, the distance L51 is made as small as possible while the depth D51 necessary for positioning is reserved, so that the thickness D5 of the sub-holder 5 can be easily reduced. When the thickness D5 is reduced, an increase in the paper gap can be suppressed.

In the present embodiment, the first fixing members 151 are screws. Accordingly, female threads are formed on inner circumferential wall surfaces forming the first fixing slots 501. When the first fixing members 151 are the screws, the fixing of the sub-holder 5 to the holder 6 can be easily released by rotating and unscrewing the screws. When the first fixing members 151 are the screws, the sub-holder 5 can be fixed to the holder 6 in the detachably-attached manner without using an adhesive.

However, the first fixing member 151 may be a member other than the screw. For example, the first fixing member 151 may include an L-shaped or T-shaped pin with its tip end in the Z1 direction bent at a right angle and an elastic member such as a leaf spring or coil spring, and may be configured to fix the sub-holder 5 to the holder 6 by using the elastic force of the elastic member.

As described above, the first fixing member 151 may have any structure as long as the first fixing member 151 can fix the holder 6 and the sub-holder 5 to each other.

Moreover, as illustrated in FIGS. 5 and 14, for example, the two first fixing members 151 are provided for each sub-holder 5. As viewed in the Z1 direction, the first fixing members 151 are arranged so as not to overlap the chip 20 and so as to sandwich the seal areas 4S between the chip 20 and the first fixing members 151.

In the case where the first fixing members 151 do not overlap the chip 20 as viewed in the Z1 direction, the load generated for fixing with the first fixing members 151 is less likely to be applied to the chip 20 than in the case where the first fixing members 151 overlap the chip 20. Moreover, as viewed in the Z1 direction, the seal member 4 is arranged between the first fixing member 151 and the chip 20, so that the distance of the chip 20 from the first fixing member 151 can be increased by the dimension of the seal member 4. This also makes the load generated for fixing with the first fixing members 151 unlikely to be applied to the chip 20.

As illustrated in FIG. 13, the holder 6 includes multiple fourth alignment portions 642. The multiple fourth alignment portions 642 are provided in the flange portions 64. As illustrated in FIG. 5, the fourth alignment portions 642 are protrusions protruding in the Z2 direction from surfaces of the flange portions 64 facing in the Z2 direction. The multiple fourth alignment portions 642 are provided corresponding to the multiple third alignment portions 102 included in the unit base 11 illustrated in FIG. 2 on a one-to-one basis.

Each of the fourth alignment portions 642 is press-fitted into one of the multiple third alignment portions 102 provided to the unit base 11, thereby positioning the liquid ejecting head 1 with respect to the unit base 11. This makes it possible to improve the precision of alignment of the multiple liquid ejecting heads 1 with the unit base 11.

In addition, the flange portions 64 are provided with mounting slots 64H. The mounting slots 64H correspond to the mounting holes 101 of the unit base 11. Each of the mounting slots 64H is a bottomed slot opened in the surface of the flange portion 64 facing in the Z2 direction and is, for example, a screw slot for mounting the liquid ejecting head 1 to the unit base 11 with a member such as a screw. The flange portions 64 are fixed to the unit base 11 with not-illustrated members such as screws inserted into the mounting holes 101 and the mounting slots 64H in this order and then tightened. As a result, the liquid ejecting head 1 is fixed to the unit base 11.

### 1-3F. Wiring Substrate 7, Relay Substrate 70, and Connector 71

As illustrated in FIG. 4, the wiring substrate 7 is provided for each head module 2. The wiring substrate 7 is inserted into the through hole 20H of the chip 20 and the through hole 25H of the channel orifice forming member 25. The wiring substrate 7 is joined to the vibration plate 204. The wiring substrate 7 protrudes from the vibration plate 204 in the Z2 direction. The wiring substrate 7 is a mounting component in which multiple wiring lines for electrically connecting the chip 20 and the relay substrate 70 are formed. The wiring substrate 7 is, for example, a flexible substrate such as a flexible printed circuit (FPC) or a chip on film (COF), or a rigid substrate. From the wiring substrate 7, each driver element E is supplied with a driving signal and a reference voltage for driving the driver element E.

The relay substrate 70 is fixed to the bottom surface of the dented portion 610 in the surface 605 facing in the Z1 direction of the flat plate portion 61 of the holder 6. The relay substrate 70 has a flat plate shape, and is fixed to the holder 6 with an adhesive or the like. The relay substrate 70 is electrically connected to the control unit 91. Multiple connectors 71 are equipped in the relay substrate 70. The multiple connectors 71 are provided for the multiple wiring substrates 7 on a one-to-one basis. An end portion of the wiring substrate 7 provided with multiple terminals is inserted into each connector 71 in a removably-inserted manner. In other words, it is preferable that wiring substrate 7 be formed of a rigid body in order to facilitate insertion and removal of the end portion of the wiring substrate 7 into and from the connector 71. In the case where the wiring substrate 7 is formed of a flexible substrate, it is desirable to bond a rigid body to the flexible substrate to support the flexible substrate. When the end portion of the wiring substrate 7 is inserted into the connector 71, the wiring substrate 7 is electrically connected to the control unit 91 via the relay substrate 70.

The relay substrate 70 is electrically connected to the multiple head modules 2. The relay substrate 70 is arranged in the Z2 direction, which is opposite to the Z1 direction, relative to the multiple head modules 2, and overlaps the multiple head modules 2 as viewed in the Z1 direction. The first alignment portions 502 are provided on the surface of the sub-holder 5 facing in the Z2 direction. This arrangement enables easy attachment and detachment for only the sub-unit 15 of the replacement target from below the holder 6 and the relay substrate 70. Therefore, there is no need to disconnect the electric connections of the sub-units 15 other than the replacement target, which simplifies the attachment and detachment work.

In the process of attaching only the sub-unit 15 as a replacement to the holder 6 from below the holder 6 as described above, the wiring substrate 7 is moved in the Z2 direction from below the connector 71 to the connector 71. Then, the wiring substrate 7 is inserted into the connector 71. As a result, the wiring substrate 7 is electrically connected to the relay substrate 70.

### 1-3G. Bushing

As illustrated in FIG. 4, bushings 521 are provided between the multiple sub-holders 5. Each bushing 521 fills a gap formed between the adjacent sub-holders 5. For example, as viewed in the Z1 direction, the bushing 521 has a shape long along the Y axis between the adjacent sub-holders 5. As illustrated in FIG. 5, bushings 522 are arranged between the holder 6 and the sub-holder 5. Specifically, the bushings 522 are arranged between the holder 6 and both longitudinal ends of the sub-holder 5. Each of the bushings 521 and 522 contains, for example, an elastic resin material.

The provision of the bushings 521 and 522 makes it possible to reduce a risk of ink mist or the like entering the storage space inside the dented portion 610 of the holder 6 from the outside of the liquid ejecting head 1.

### 2. Modifications

The embodiment described above as the example may be modified in various manners. Examples of specific modifications applicable to the above-described embodiment will be described below. Any two or more modifications selected from the following examples may be combined as appropriate unless they are mutually inconsistent.

### 2-1. First Modification

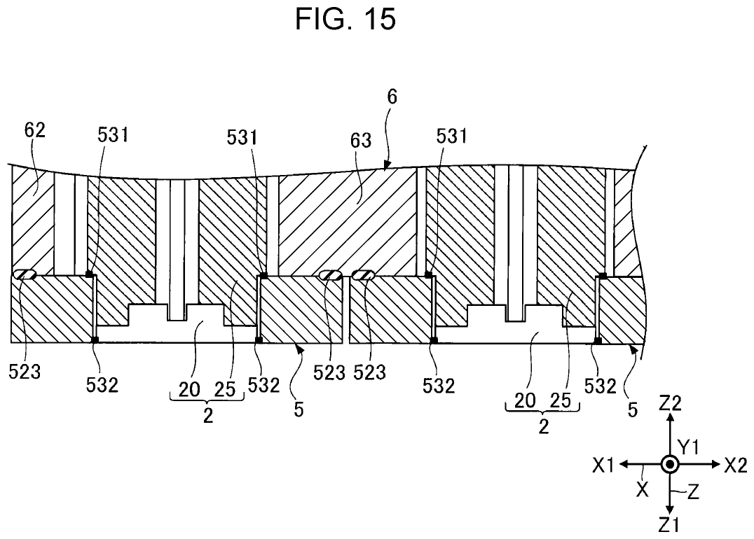

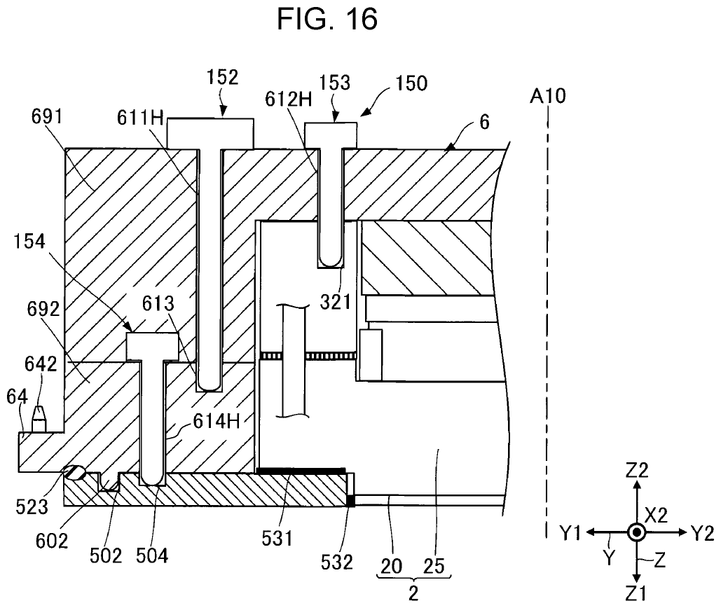

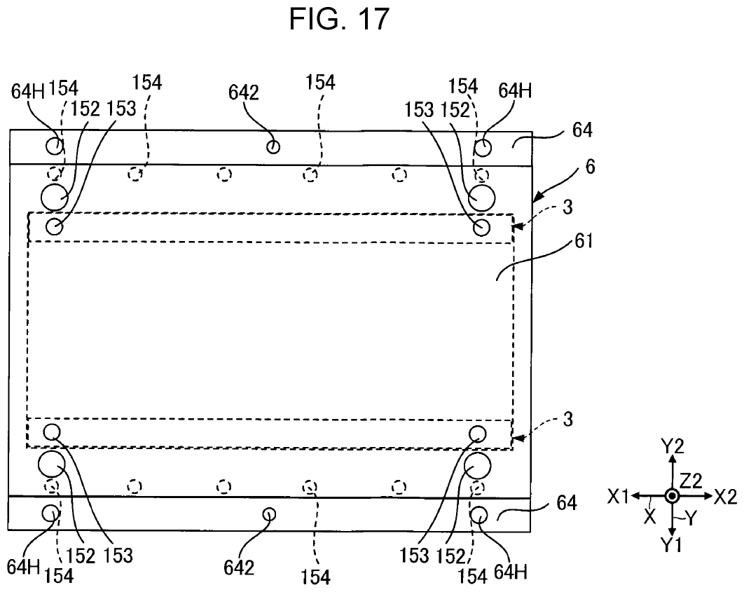

FIGS. 15 and 16 are cross-sectional views of parts of a liquid ejecting head 1 in a first modification. FIG. 17 is a topside view of the liquid ejecting head 1 in the first modification.

In the first modification illustrated in FIG. 15, bushings 523 are provided. Although not illustrated in details, each bushing 523 has a rectangular frame shape along an outer periphery of the sub-holder 5 as viewed in the Z1 direction. These bushings 523 can prevent ink mist or the like from entering the space in the dented portion 610 of the holder 6. Here, the multiple bushings 523 may be integrally formed as a common member provided in common to the multiple sub-holders 5.

As illustrated in FIG. 16, in the first modification, the sub-holder 5 and the head module 2 are sealed with molds formed of adhesives 531 and 532. The adhesive 531 forms the mold that seals the channel orifice forming member 25 and the sub-holder 5. The adhesive 531 overlaps the seal member 4 as viewed in the Z1 direction. The adhesive 532 forms the mold that seals the chip 20 and the sub-holder 5. Although not illustrated in details, the adhesive 531 is provided in a rectangular frame shape surrounding the opening 5H as viewed in the Z1 direction. The adhesive 532 is provided along an inner peripheral wall of the opening 5H. These adhesives 531 and 532 can prevent ink mist or the like from entering the space in the dented portion 610 of the holder 6.

The holder 6 of the liquid ejecting head 1 in the first modification includes a first member 691 and a second member 692. The first member 691 and the second member 692 are formed as separate members. The first member 691 is equivalent to the upper portion of the holder 6 in the first embodiment described above. Accordingly, the first member 691 includes the flat plate portion 61 and a part of the sidewall 62. The second member 692 is equivalent to the lower portion of the holder 6 in the first embodiment described above. The second member 692 includes a part of the sidewall 62 and the multiple partition walls 63.

The first member 691 is provided with multiple fixing holes 611H and 612H. The second member 692 is provided with multiple fixing slots 613 and multiple fixing holes 614H. The multiple fixing slots 613 and 614H correspond to the multiple fixing holes 611H on a one-to-one basis, and coincide with the multiple fixing holes 611H as viewed in the Z1 direction. The fixing holes 611H and 612H are holes passing through the first member 691 in the thickness direction. The fixing holes 611H do not overlap the dented portion 610 as viewed in the Z1 direction. The fixing holes 612H overlap the dented portion 610 as viewed in the Z1 direction. The fixing holes 614H pass through the second member 692 in the thickness direction. The fixing holes 614H do not overlap the dented portion 610 as viewed in the Z1 direction. The fixing holes 614H are provided for each sub-holder 5. The fixing slots 613 are bottomed slots opened on a surface of the second member 692 facing in the Z2 direction.

In the first modification, each common channel member 3 is provided with fixing slots 321. The fixing slots 321 are bottomed slots opened in a surface of the common channel member 3 facing in the Z2 direction. The fixing slot 321 is provided for each fixing hole 612H and coincides with the fixing hole 612H as viewed in the Z1 direction.

In the first modification, the sub-holder 5 is provided with fixing slots 504. The fixing slots 504 are bottomed slots opened in the surface 512 of the sub-holder 5 facing in the Z2 direction. The fixing slot 504 is provided for each fixing hole 614H and coincides with the fixing hole 614H as viewed in the Z1 direction.

The liquid ejecting head 1 in the first modification includes a fixing member group 150. The fixing member group 150 includes multiple fixing members 152, 153, and 154.

The fixing member 152 is inserted into the fixing hole 611H and the fixing slot 613 in this order. The fixing member 152 fixes the first member 691 and the second member 692 to each other. The fixing member 153 is inserted into the fixing hole 612H and the fixing slot 321 in this order. The fixing member 153 fixes the first member 691 and the common channel member 3 to each other. The fixing member 154 is inserted into the fixing hole 614H and the fixing slot 504 in this order. The fixing member 154 fixes the second member 692 and the sub-holder 5 to each other.

As illustrated in FIG. 17, for example, the multiple fixing members 152 are provided near the corners of the holder 6 having a rectangular shape as viewed in the Z1 direction. For example, the multiple fixing members 153 are provided near the corners of the holder 6 having the rectangular shape as viewed in the Z1 direction. The fixing members 154 are provided on a per-sub-holder 5 basis.

The fixing member group 150 fixes the sub-holders 5 to the holder 6, and indirectly fixes the multiple head modules 2 to the holder 6. With the multiple fixing members 153 provided, the common channel members 3 are not bonded to the holder 6 but are fixed to the holder 6 in a detachably-attached manner. Thus, in addition to the sub-units 15, the common channel members 3 are also replaceable.

The fixing members 152, 153, and 154 are, for example, screws, but may be other members such as L-shaped or T-shaped pins described above.

It is preferable that the fixing member 152 be longer than the fixing member 154 and that the fixing member 152 and the fixing member 154 have male threads with the same outer profile and the same pitch. First, the fixing members 152 are removed from the fixing slots 613, and thereby the first member 691 is detached from the second member 692. Next, the fixing members 154 are removed from the fixing slots 504. After that, the fixing members 152, which are longer than the fixing members 154, are fastened to the fixing slots 504, so that the sub-holder 5 can be moved in the Z1 direction relative to the second member 692. Therefore, the press-fit of the second alignment portions 602 in the first alignment portions 502 can be easily released.

### 2-2. Second Modification

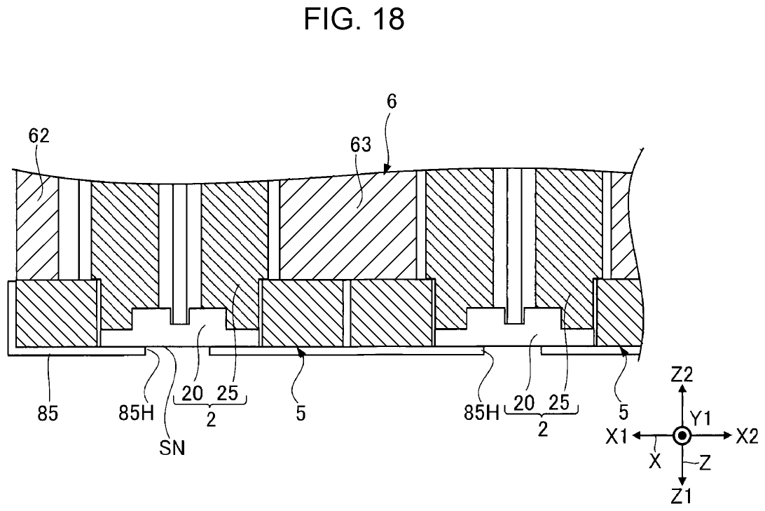

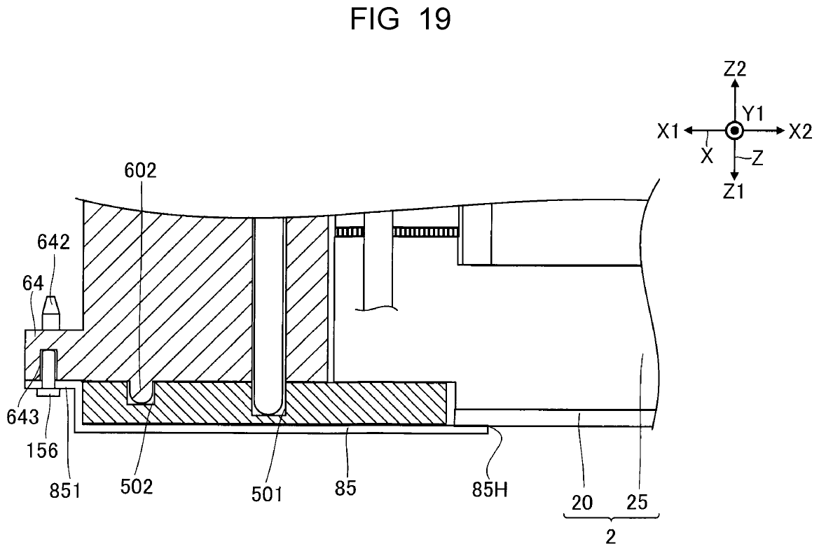

FIGS. 18 and 19 are cross-sectional views of parts of a liquid ejecting head 1 in a second modification. The liquid ejecting head 1 in the second modification in FIGS. 18 and 19 includes a cover 85. The cover 85 is fixed to the flange portions 64 of the holder 6.

The cover 85 is provided in common to the multiple sub-holders 5, and covers parts of the multiple sub-holders 5 except for the openings 5H. The cover 85 is a plate-shaped member and is made of, for example, a metal. The cover 85 is located in the Z1 direction relative to the multiple sub-holders 5, and is in contact with the multiple sub-holders 5. The cover 85 includes multiple opening portions 85H. The multiple opening portions 85H are provided for the nozzle surfaces SN of the multiple head modules 2 on a one-to-one basis, and expose the nozzle surfaces SN.

Moreover, the cover 85 covers sidewall surfaces of the multiple sub-holders 5. A part of the cover 85 includes a flange 851 in contact with a surface of each flange portion 64 facing in the Z2 direction. In the flange 851, a through hole to which a mounting screw 156 is to be inserted is formed. In the flange portion 64, a thread slot 643 is formed which coincides with the above through hole as viewed in the Z1 direction. The thread slot 643 is a bottomed slot opened in the surface of the flange portion 64 facing in the Z1 direction. The cover 85 is fixed to the flange portions 64 with the mounting screws 156 inserted and tightened in the thread slots 643 in a state where the cover 85 is in contact with the multiple sub-holder 5.

The cover 85 thus provided reduces the entry of ink mist into the dented portion 610 of the holder 6.

### 2-3. Third Modification

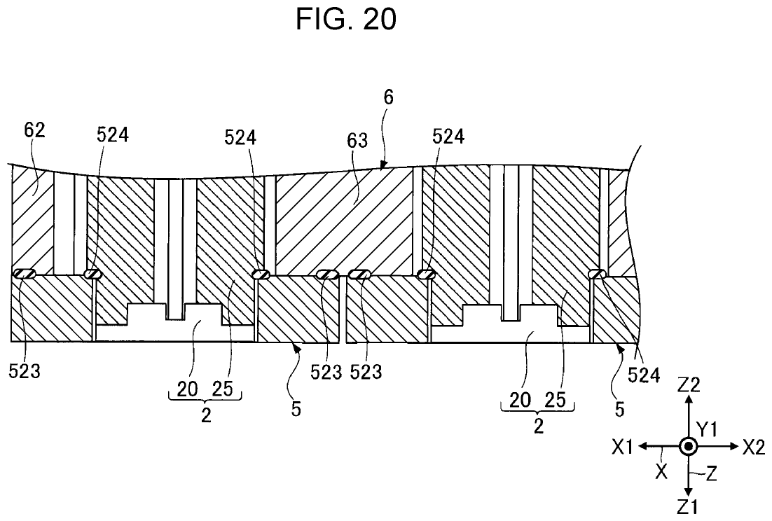

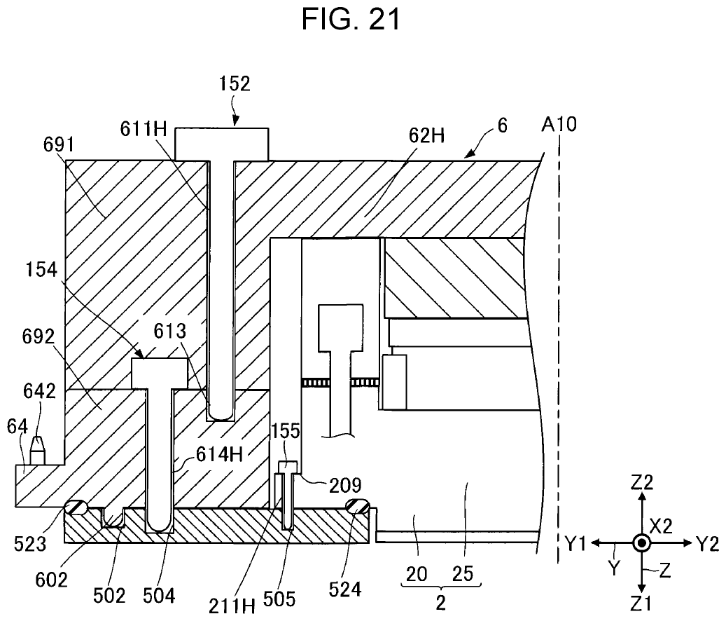

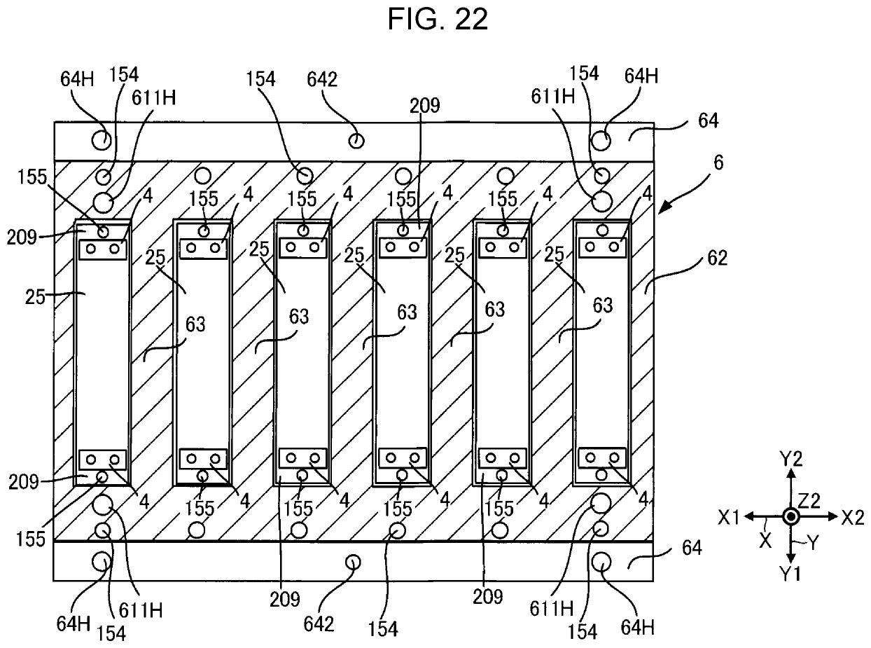

FIGS. 20 and 21 are cross-sectional views of parts of a liquid ejecting head 1 in a third modification. FIG. 22 is a view illustrating the second member 692 included in the holder 6 in the third modification. Hereinafter, mainly different points from those in the first modification will be described.

In the third modification illustrated in FIG. 20, bushings 524 are provided. Although not illustrated in details, each bushing 524 has a rectangular frame shape surrounding the opening 5H of the sub-holder 5 as viewed in the Z1 direction. These bushings 524 can prevent ink mist or the like from entering the space in the dented portion 610 of the holder 6.

As illustrated in FIGS. 21 and 22, each channel orifice forming member 25 in the third modification includes flanges 209. The flanges 209 are provided in the Y1 direction and the Y2 direction relative to the chip 20 as viewed in the Z1 direction. As illustrated in FIG. 21, each flange 209 is provided with a fixing hole 211H. The sub-holder 5 is provided with a fixing slot 505 corresponding to the fixing hole 211H. The fixing slot 505 is a bottomed slot opened in the surface of the sub-holder 5 facing in the Z2 direction. The fixing slot 505 is provided corresponding to the fixing hole 211H and coincides with the fixing hole 211H as viewed in the Z1 direction.

The fixing member group 150 in the third modification includes multiple fixing members 155, 152, and 154. The fixing member 155 is inserted into the fixing hole 211H and the fixing slot 505 in this order. The fixing member 155 fixes the channel orifice forming member 25 and the sub-holder 5 to each other. The fixing members 155 are provided on a per-sub-holder 5 basis.

The fixing member group 150 fixes the sub-holders 5 to the holder 6 and fixes the head modules 2 to the sub-holders 5, thereby indirectly fixing the multiple head modules 2 to the holder 6. Since the multiple fixing members 155 are provided, each head module 2 is fixed to the sub-holder 5 without using an adhesive or the like. For this reason, the head module 2 can be easily attached to and detached from the sub-holder 5. If the fixing members 155 are screws in particular, the head module 2 can be particularly easily attached to and detached from the sub-holder 5. However, the fixing members 155 may be, for example, L-shaped or T-shaped pins or the like. In the case where the head module 2 is fixed to the sub-holder 5 with the fixing members 155, misalignment of the multiple head modules 2 can be reduced as compared to the case of the fixing with an adhesive.

The bushing 524, the sub-holder 5, the head module 2, and the seal member 4 described above overlap each other as viewed in the Z1 direction. This structure reduces the risk of the flange 209 being deformed due to the reaction force of the seal member 4 as compared with the case where they do not overlap each other.

### 2-5. Fifth Modification

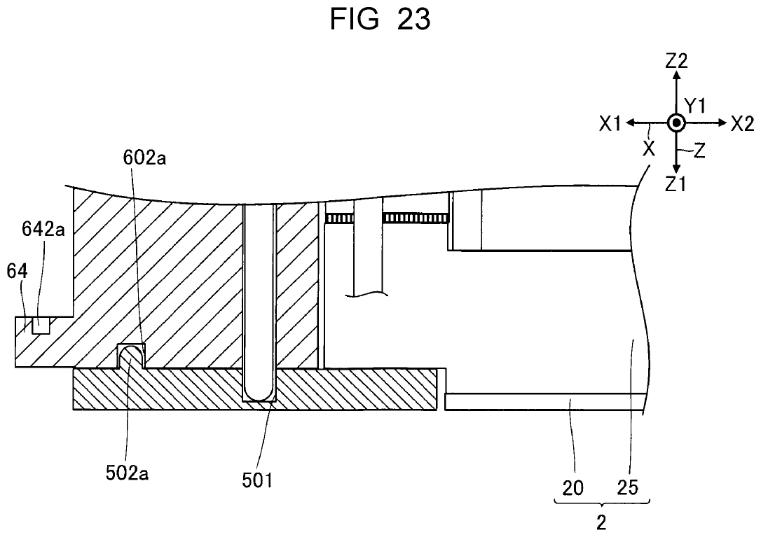

FIG. 23 is a cross-sectional view of a part of a liquid ejecting head 1 in a fifth modification. In the liquid ejecting head 1 in the fifth modification illustrated in FIG. 23, a first alignment portion 502a is a pin protruding in the Z2 direction from the surface of the sub-holder 5 facing in the Z2 direction. A second alignment portion 602a is a bottomed slot opened in the surface of the holder 6 facing in the Z1 direction. The second alignment portion 602a is a dented portion, in other words, a recess, formed in the holder 6 in the Z1 direction. In the second alignment portion 602a, the first alignment portion 502a is press-fitted to position the sub-holder 5 with respect to the holder 6.

Even such first alignment portion 502a and second alignment portion 602a also enable easy positioning for attaching each sub-holder 5 to the holder 6 as in the first embodiment. Moreover, the alignment of the multiple sub-holders 5 with the holder 6 can be made with high precision. Thus, the alignment of the multiple head modules 2 with the holder 6 can be made with high precision. In addition, in order to replace only some of the multiple head modules 2, there is no need to realign all the head modules 2.

As described in the first embodiment and the fifth modification, the multiple head modules 2 can be aligned with each other with high precision in the simple method including press-fitting either the second alignment portions 602 or the first alignment portions 502 into the other alignment portions.

The fourth alignment portion 642a is a bottomed slot opened in the surface of the flange portion 64 facing in the Z2 direction. The fourth alignment portion 642a is a dented portion, in other words, a recess, formed in the flange portion 64 in the Z1 direction. Although not illustrated, a third alignment portion 102 in this case is formed as a protrusion provided to the unit base 11. In the fourth alignment portion 642a, the above third alignment portion 102 is press-fitted to position the liquid ejecting head 1 with the unit base 11. Therefore, it is possible to improve the precision of alignment of the multiple liquid ejecting heads 1 with the unit base 11.

### 2-6. Sixth Modification

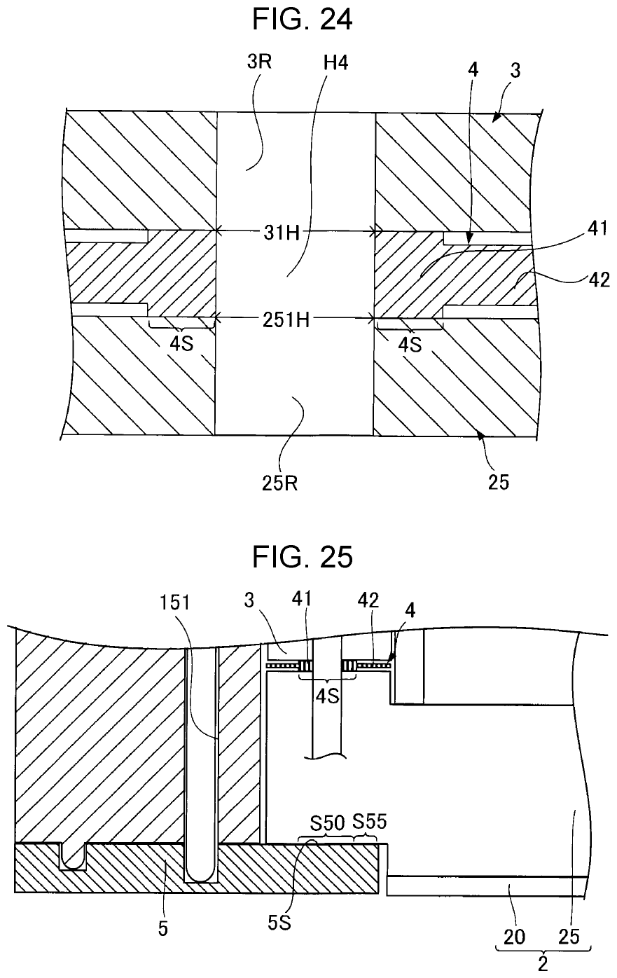

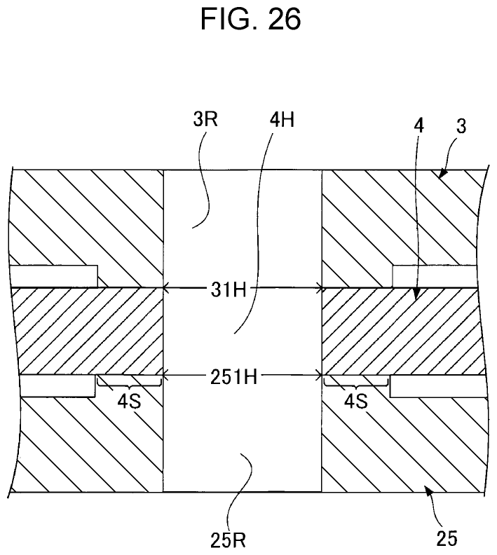

FIG. 24 is a cross-sectional view of a seal member 4 and its surrounding area in a sixth modification. FIG. 25 is a cross-sectional view of a part of a liquid ejecting head 1 in the sixth modification. In the sixth modification illustrated in FIG. 24, the thickness of the seal member 4 is not constant. The seal member 4 in the sixth modification includes a thick portion 41 and a thin portion 42. The thick portion 41 is located near an inner wall surface forming an orifice H4 and is thicker than the thin portion 42. The thin portion 42 is located outside the thick portion 41.

In the case of the sixth modification, the thick portion 41 in the seal member 4 has the seal area 4S. The thick portion 41 is in contact with the channel orifice forming member 25 and the common channel member 3, and is held between the channel orifice forming member 25 and the common channel member 3.

As illustrated in FIG. 25, the first fixing member 151 for fixing the head module 2 and the common channel member 3 is arranged so as not to overlap the chip 20 and so as to sandwich the seal area 4S between the first fixing member 151 and the chip 20 as viewed in the Z1 direction. Moreover, the support surface 5S includes an area S55 arranged between the seal area 4S and the chip 20 as viewed in the Z1 direction. This structure can reduce the influence of the reaction force of the seal member 4 on the chip 20 as compared with the case where the support surface 5S does not include the area S55.

### 2-7. Seventh Modification

FIG. 26 is a cross-sectional view of a seal member 4 and its surrounding area in a seventh modification. In the seventh modification illustrated in FIG. 26, the seal member 4 includes a portion out of contact with both the common channel member 3 and the channel orifice forming member 25. In the seventh modification, a portion of the seal member 4 near the communication orifice 4H serves as the seal area 4S. As described above, depending on the shapes of the common channel member 3 and the channel orifice forming member 25, the seal member 4 may include a portion that is out of contact with both the common channel member 3 and the channel orifice forming member 25 and that is not held between the common channel member 3 and the channel orifice forming member 25. In the seal member 4, the portion held between the common channel member 3 and the channel orifice forming member 25 serves as the seal area 4S.

### 2-8. Eighth Modification

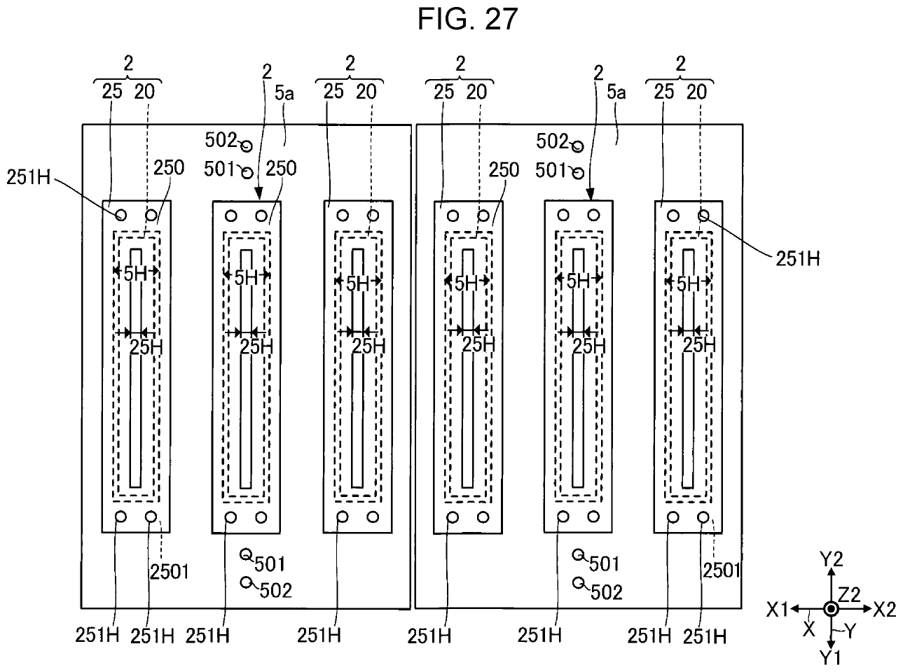

FIG. 27 is a cross-sectional view illustrating a first alignment portion and a second alignment portion in an eighth modification. In the eighth modification illustrated in FIG. 27, one sub-holder 5a holds multiple head modules 2. In this way, one sub-holder 5a does not necessarily have to hold one head module 2. In this case, one sub-holder 5a includes multiple openings 5H corresponding to the multiple head modules 2. In this case, the sub-holder 5a serves as a reference for positioning the multiple head modules 2. In the example illustrated, one sub-holder 5a supports three head modules 2. In other words, the sub-holder 5a is provided for every three head modules 2. Two first alignment portions 502 are provided for each sub-holder 5a. Thus, the two first alignment portions 502 are provided in common to the three head modules 2. The sub-holder 5a serves as the reference for positioning the three head modules 2. Two first fixing slots 501 are also provided for each sub-holder 5a. Thus, the two first fixing slots 501 are provided in common to the three head modules 2.

In the eighth modification, one sub-holder 5a holds multiple head modules 2. In other words, one sub-holder 5a holds two or more head modules 2. For example, two or more head modules 2 to be replaced at similar timings are held by one sub-holder 5a. Thus, the two or more head modules 2 to be replaced at the similar timings may be collectively replaced, which facilitates the replacement work.

In the eighth modification, for example, the sub-holder 5a preferably holds multiple head modules 2 to eject the same type of liquid among the multiple head modules 2. This makes it possible to collectively replace head modules 2 having similar life spans, such as head modules 2 to eject a type of liquid whose ejection frequency is high (for example, a black ink, a white ink, a pre-treatment liquid such as a reaction liquid to coagulate pigments contained in an ink, a post-treatment liquid such as an overcoat liquid, or the like). As a result, the workability for replacement is improved. However, the two or more head modules 2 held by one sub-holder 5a may eject different types of inks. One head module 2 may be capable of ejecting one type of ink or two or more types of inks.

### 2-9. Other Modifications

In the above description, the seal members 4 are provided for each head module 2, but a single seal member 4 may be provided in common to the multiple head modules 2.

In addition, for example, the holder 6 may be provided with a through hole formed only for use to release the press-fits between the first alignment portions 502 and the second alignment portions 602. For example, the above through hole may be a hole that passes through the holder 6 in directions in which the first alignment portions 502 are inserted into and removed from the second alignment portions 602 and that has a larger opening area than the opening area of the first fixing hole 61H.

The “liquid ejecting apparatus” may be used in a variety of apparatuses, including facsimile machines and copy machines, in addition to apparatuses dedicated to printing. The use of the liquid ejecting apparatus is not limited to printing. For example, a liquid ejecting apparatus to eject a solution of a pigment may be used as a manufacturing apparatus to form color filters of display devices such as liquid display panels. Instead, a liquid ejecting apparatus to eject a solution of a conductive material may be used as a manufacturing apparatus to form wiring and electrodes for relay substrates. Alternatively, a liquid ejecting apparatus to eject a solution of an organic substance related to living organisms may be used as a manufacturing apparatus to produce, for example, bio chips.

The present disclosure is described above based on the preferred embodiments, but should not be limited to the above embodiments. The structure of each component of the present disclosure may be replaced with any structure having the same function as in the above embodiments, or any structure may be added as needed.

What is claimed is:

1. A liquid ejecting head comprising:
a plurality of head modules each of which ejects a liquid in a first direction;
a plurality of metallic sub-holders each of which holds at least one head module among the plurality of head modules; and
a metallic holder to which the plurality of sub-holders are fixed in a detachably-attached manner, wherein
each of the plurality of sub-holders includes a first alignment portion, and
the holder includes a plurality of second alignment portions which are inserted into or receive a plurality of the first alignment portions in a press-fit manner, thereby positioning the plurality of sub-holders with respect to the holder.

2. The liquid ejecting head according to claim 1, wherein
the plurality of second alignment portions are arranged in a surface of the holder facing in the first direction,
the first alignment portion is arranged in a surface of the sub-holder facing in a second direction opposite to the first direction, and
the at least one head module is supported by the surface of the sub-holder facing in the second direction.

3. The liquid ejecting head according to claim 2, wherein
each of the head modules includes
a nozzle plate having a plurality of nozzles that eject the liquid, and
a supported surface located in the second direction relative to the nozzle plate and facing in the first direction,
each of the sub-holders includes
an opening from which the plurality of nozzles of the head module are exposed to outside, and
a support surface facing in the second direction, and
the head module is held by the sub-holder with the supported surface put in contact with the support surface.

4. The liquid ejecting head according to claim 3, wherein
each of the head modules includes a channel orifice forming member which includes the supported surface and in which a channel is formed, and
a part of the channel orifice forming member is inserted in the opening of the sub-holder.

5. The liquid ejecting head according to claim 3, wherein a surface of the sub-holder facing in the first direction and a surface of the nozzle plate facing in the first direction are approximately flush with each other.

6. The liquid ejecting head according to claim 1, further comprising a common channel member including one or more channels which communicate with the plurality of head modules, wherein
the common channel member is arranged in a second direction relative to the plurality of head modules, the second direction being opposite to the first direction, and overlaps the plurality of head modules as viewed in the first direction, and
the first alignment portion is provided in a surface of the sub-holder facing in the second direction.

7. The liquid ejecting head according to claim 1, further comprising a relay substrate which is electrically connected to the plurality of head modules, wherein
the relay substrate is arranged in a second direction relative to the plurality of head modules, the second direction being opposite to the first direction, and overlaps the plurality of head modules as viewed in the first direction, and
the first alignment portion is provided in a surface of the sub-holder facing in the second direction.

8. The liquid ejecting head according to claim 1, wherein each of the plurality of sub-holders holds two or more of the head modules.

9. The liquid ejecting head according to claim 8, wherein each of the sub-holders holds two or more head modules which eject the same type of liquid among the plurality of head modules.

10. The liquid ejecting head according to claim 2, wherein the first alignment portion is a bottomed slot provided in the surface of the sub-holder facing in the second direction and recessed in the first direction, or a pin protruding in the second direction from the surface of the sub-holder facing in the second direction.

11. The liquid ejecting head according to claim 1, further comprising a plurality of first fixing members that fix the plurality of sub-holders to the holder in a detachably-attached manner, wherein
each of the plurality of sub-holders includes a first fixing slot in a dented shape having a bottom surface,
the holder includes a plurality of first fixing holes which pass through the holder in the first direction, and
each of the first fixing members is inserted in the first direction into one of the first fixing holes and one of the first fixing slots in this order.

12. The liquid ejecting head according to claim 11, wherein
the plurality of second alignment portions are arranged in a surface of the holder facing in the first direction,
the first alignment portion is provided in a surface of the sub-holder facing in a second direction opposite to the first direction, and
a depth of the first fixing hole is greater a depth of the first fixing slot.

13. The liquid ejecting head according to claim 12, wherein
a distance from the bottom surface of the first fixing slot to a surface of the sub-holder facing in the first direction is greater than the depth of the first fixing slot.

14. The liquid ejecting head according to claim 12, wherein the first fixing member is a screw.

15. A liquid ejecting apparatus comprising:
a plurality of the liquid ejecting heads according to claim 1; and
a unit base which holds the plurality of liquid ejecting heads.

16. The liquid ejecting head according to claim 1, wherein the holder includes a fourth alignment portion which is inserted into or receives one of a plurality of third alignment portions provided to a unit base which holds a plurality of the liquid ejecting heads, thereby positioning the liquid ejecting head with respect to the unit base.

17. A liquid ejecting apparatus comprising:
a plurality of the liquid ejecting heads according to claim 16; and
a unit base which includes the plurality of third alignment portions and holds the plurality of liquid ejecting heads.
